(19) United States
(12) Patent Application Publication
(10) Pub. No.: US 2023/0325466 A1
(43) Pub. Date: Oct. 12, 2023

(54) USE OF MATRIX PARTITIONING TO DETERMINE THE WIGNER ROTATION MATRIX (THOMAS ROTATION MATRIX) IN RODRIGUES FORM SPECIFYING THE WIGNER ANGLE (THOMAS ANGLE) AND THE AXIS BY MULTIPLICATION OF THREE LORENTZ BOOST MATRICES

(71) Applicant: Bernhard Strohmayer, Munchen (DE)

(72) Inventor: Bernhard Strohmayer, Munchen (DE)

(21) Appl. No.: 18/332,987

(22) Filed: Jun. 12, 2023

(51) Int. Cl. G06F 17/16

(52) U.S. Cl. CPC G06F 17/16

(57) ABSTRACT

For two given restricted Lorentz transformation matrices ^{A}Lη and ^{B}Lη with identical first column vectors the calculation of the rotation matrix Rη=(^{A}Lη)^{-1 B}Lη can according to the invention be simplified by matrix partitioning. Using this method the calculation of the Wigner rotation matrix (Thomas rotation matrix) ^{W}Rη, which is for two given Lorentz boost matrices B₁η, B₂η defined by (B₁η)(B₂η)=(B₃η)(^{W}Rη) with B₃η being a further Lorentz boost matrix, can be simplified by making the identifications ^{A}Lη=B₃η and ^{B}Lη=(B₁η)(B₂η). Since the matrix formed by the four four-vectors of a local frame of a timelike worldline in 4-dimensional Minkowski space can be interpreted as a proper time dependent restricted Lorentz transformation matrix, said method can also be used to simplify the calculation of the rotation matrix linking two different local frames of a given timelike worldline.

### FIELD OF THE INVENTION

It is recommended to read this U.S. patent application Ser. No. ______ in the form of the pdf-document originally filed, which can be downloaded under https://patentcenter.uspto.gov/applications/XXXXXXXX/ifw/docs (pdf-link in the line with the document description ‘specification’), since the application as published by the USPTO is presumably riddled with mistakes.

This invention relates to the manipulation of matrices representing restricted Lorentz transformations [4, chapter 6 on p. 167, in particular subchapter “6.3.3. Restricted Lorentz Group” on p. 174] in four-dimensional Minkowski space.

In this application we use for the Minkowski metric the convention

$$η = ( \begin{matrix}- 1 & 0 & 0 & 0 \\ 0 & 1 & 0 & 0 \\ 0 & 0 & 1 & 0 \\ 0 & 0 & 0 & 1\end{matrix} )$$

Greek indices run from 0 to 3, latin indices run from 1 to 3. Capital letters L, R and B denote contravariant tensors of rank 2 with matrix components L^{μν}, R^{μν}, B^{μν}. The products Lη, Rη and Bη denote mixed tensors of rank 2 with matrix components L^{μ}_{ν}, R^{μ}_{ν}, B^{μ}_{ν}. The products ηLη, ηRη and ηBη denote covariant tensors of rank 2 with matrix components L_{μν}, R_{μν}, B_{μν}.

A point · between four-vectors denotes always the Minkowski pseudo scalar product (a·u=a^{T}ηu=a_{ν}u^{ν}), a point · between three-dimensional vectors denotes always a normal Euclidian scalar product (a·u=a^{T}u) and a point · between a matrix and another matrix or a vector denotes always matrix multiplication, however the latter point is most often omitted. Throughout the application documents three-dimensional quantities are always denoted by bold symbols like r, u, a, ω, R, L, B in contrast to the associated four-dimensional quantities r, u, a, R, L, B. Three-dimensional vectors with a hat \hat{ } such as \hat{ω} denote always unit vectors.

### BACKGROUND OF THE INVENTION

Textbooks on special relativity like [4, equ.(4.42) on p. 108, equ.(4.41) on p. 107, equ.(4.19) on p. 102, equ.(2.12) on p. 35 and remark 2.9 on p. 36] or [8, equ.(6.6) on p. 164 and equ.(4.23) on p. 118] or [7, equ.(11.36) on p. 532 and equ.(11.17) on p. 525] or [5, equ.(17.36) on p. 373] disclose that if a massive particle is moving with constant speed v=(υ¹, υ², υ³)^{T} relative to an inertial frame with time coordinate t, then the particle is represented in 4-dimensional Minkowski space by the timelike worldline

$$r ( τ ) = ( \begin{matrix}1 \\ \frac{v}{c}\end{matrix} ) \cdot t ( τ ) = ( \begin{matrix}1 \\ \frac{v}{c}\end{matrix} ) \cdot \frac{1}{{\underbrace{\sqrt{1 - {( \frac{v}{c} )}^{2}}}}_{γ}} \cdot τ = ( \begin{matrix}1 \\ \frac{v}{c}\end{matrix} ) \cdot \frac{1}{{\underbrace{\sqrt{1 - {\sum }_{i = 1}^{3} {( \frac{{v}^{i}}{c} )}^{2}}}}_{γ}} \cdot τ \qquad ( 1 )$$

with τ being the proper time of the particle and with c denoting the speed of light. In line with [4, equ. 2.12 on p. 35] we define the four-velocity u of the particle by

$$u = \frac{1}{c} \frac{dr}{d τ} = ( \begin{matrix}{u}^{0} \\ u\end{matrix} ) = ( \begin{matrix}\sqrt{1 + {u}^{2}} \\ u\end{matrix} ) = ( \begin{matrix}{u}^{0} \\ {u}^{1} \\ {u}^{2} \\ {u}^{3}\end{matrix} ) = γ ( \begin{matrix}1 \\ \frac{v}{c}\end{matrix} ) = γ ( \begin{matrix}1 \\ \frac{{v}^{1}}{c} \\ \frac{{v}^{2}}{c} \\ \frac{{v}^{3}}{c}\end{matrix} ) \qquad ( 2 )$$

such that

u·u=u^{T}ηu=u_{μ}u^{μ}=η_{μν}u^{ν}u^{μ}=−1 (3)

Other authors like [8, equ.(6.6) on p. 164], [7, equ.(11.36) on p. 532], [5, line between equ.(17.30) and equ.(17.31) on p. 372 or equ.(17.36) on p. 373] or [1, p. 819, left col., paragraph preceding equ.(5)] define the four-velocity by

$$u = \frac{dr}{d τ} ,$$

in which case equ.(3) assumes the form u·u=−c²[8, Exercise 6.2.1. on p. 164], [5, equ.(17.20) on p. 369] and [1, p. 819, left col., paragraph following equ.(5)]. Also in the latter case equ.(3) remains valid if one chooses natural units with c=1.

A Lorentz transformation matrix Lη=(L^{μ}_{ν}) is a 4×4-matrix representing a mixed tensor, which fulfills one of the four following equivalent conditions ([4, p. 171]):

(Lηb)·(Lηc)=(Lηb)^{T}η(Lηc)=b^{T}ηc=b·c for all four-vectors b,c (4)

⇔(Lη)^{T}η(Lη)=η (5)

⇔(Lη)⁻¹=η(Lη)^{T}η (6)

⇔η_{αβ}L^{α}_{μ}L_{ν}^{β}=η_{μν} (7)

A Lorentz transformation matrix, which transforms coordinates in a right handed Minkowski-orthogonal basis moving along a straight timelike worldline as defined in equ.(1) into coordinates in a right-handed Minkowski-orthogonal basis at rest, has to be a restricted Lorentz transformation matrix, i.e. it has to obey additionally the two following conditions ([4, equ.(6.18) on p. 174]):

det(Lη)=1 and L⁰₀≥1 (8)

These conditions exclude time and space inversions and ensure that the particle is moving in the future direction [4, p. 16].

Examples of restricted Lorentz transformations are purely spatial rotations

$$R η = ( \begin{matrix}1 & {0}^{T} \\ 0 & R\end{matrix} ) with R ∈ SO ( 3 , ) and 0 := ( \begin{matrix}0 \\ 0 \\ 0\end{matrix} ) , \qquad ( 9 )$$

$${( R η )}^{T} = {( R η )}^{- 1} ⇔ {R}^{T} = {R}^{- 1} and det ( R η ) = 1 ⇔ det R = 1$$

and Lorentz boosts, which are also called pure Lorentz transformations or special Lorentz transformations (some authors denote only boosts as Lorentz transformations and use different expressions for other transformations of the Lorentz group or of the restricted Lorentz group). The matrix of a Lorentz boost can be brought in the following form ([3, equ.(3-46) on p. 66 and equ.(3-33) on p. 53], [4, equ.(6.72) on p. 198]):

$$B η = ( \begin{matrix}{u}^{0} & {u}^{T} \\ u & B\end{matrix} ) = ( \begin{matrix}{u}^{0} & {u}^{T} \\ u & 1 + \frac{{uu}^{T}}{{u}^{0} + 1}\end{matrix} ) with 1 := ( \begin{matrix}1 & 0 & 0 \\ 0 & 1 & 0 \\ 0 & 0 & 1\end{matrix} ) \qquad ( 10 )$$

$${( B η )}^{- 1} = ( \begin{matrix}{u}^{0} & - {u}^{T} \\ - u & {B}^{T}\end{matrix} ) = ( \begin{matrix}{u}^{0} & - {u}^{T} \\ - u & 1 + \frac{{uu}^{T}}{{u}^{0} + 1}\end{matrix} ) \qquad \text{(11)}$$

$${B}^{- 1} {=}^{{↓}^{annex 1}} 1 - \frac{{uu}^{T}}{{u}^{0} ( {u}^{0} + 1 )} \qquad \text{(12)}$$

Note that other authors define the boost and the inverse boost exactly the other way around ([8, equ.(1.45) on p. 25], [7, equ.(11.98) on p. 547]).

It is further known from textbooks ([4, chapter “6.5. Polar Decomposition” on p. 191-193]), that any restricted Lorentz transformation matrix Lη can be written in a unique way as the product of a boost matrix Bη and a rotation matrix Rη:

Lη=(Bη)(Rη) (13)

The restricted Lorentz transformation matrices form with the matrix multiplication a group in the mathematical sense ([4, p. 174, middle paragraph]), i.e. the product of two restricted Lorentz transformation matrices yields always another restricted Lorentz transformation matrix. But the Lorentz boost matrices do not form a subgroup in the mathematical sense, i.e. the product of two Lorentz boost matrices B₁η, B₂η does in general not yield another Lorentz boost matrix, but a restricted Lorentz transformation matrix, which can as said above be decomposed in the product of another Lorentz boost matrix B₃η and a rotation matrix ^{W}Rη called Wigner rotation matrix or Thomas rotation matrix ([4, equ.(6.100) on p. 209]):

$$( {B}_{1} η ) ( {B}_{2} η ) = ( {B}_{3} η ) {(}^{W} R η ) ⇔ ( \begin{matrix}{u}_{1}^{0} & {u}_{1}^{T} \\ {u}_{1} & {B}_{1}\end{matrix} ) ( \begin{matrix}{u}_{2}^{0} & {u}_{2}^{T} \\ {u}_{2} & {B}_{2}\end{matrix} ) = ( \begin{matrix}{u}_{3}^{0} & {u}_{3}^{T} \\ {u}_{3} & {B}_{3}\end{matrix} ) ( \begin{matrix}1 & {0}^{T} \\ 0 & {}^{W} R\end{matrix} ) ⇔ ( \begin{matrix}{u}_{1}^{0} {u}_{2}^{0} + {u}_{1}^{T} {u}_{2} & {u}_{1}^{0} {u}_{2}^{T} + {u}_{1}^{T} {B}_{2} \\ {u}_{2}^{0} {u}_{1} + {B}_{1} {u}_{2} & {u}_{1} {u}_{2}^{T} + {B}_{1} {B}_{2}\end{matrix} ) = ( \begin{matrix}{u}_{3}^{0} & {u}_{3}^{T} & {}^{W} R \\ {u}_{3} & {B}_{3} & {}^{W} R\end{matrix} ) \qquad ( 14 )$$

The third Lorentz boost matrix B₃η can easily be determined. Firstly from the preceding equation one can directly read that the first column vector of the third Lorentz boost matrix B₃η is given by

$$( \begin{matrix}{u}_{3}^{0} \\ {u}_{3}\end{matrix} ) = ( \begin{matrix}{u}_{1}^{0} {u}_{2}^{0} + {u}_{1}^{T} {u}_{2} \\ {u}_{2}^{0} {u}_{1} + {B}_{1} {u}_{2}\end{matrix} ) \qquad ( 15 )$$

Secondly one can see from equ.(10) that a Lorentz boost matrix is fully determined by its first column vector, i.e.

$${B}_{3} η = ( \begin{matrix}{u}_{3}^{0} & {u}_{3}^{T} \\ {u}_{3} & {B}_{3}\end{matrix} ) = ( \begin{matrix}{u}_{3}^{0} & {u}_{3}^{T} \\ {u}_{3} & 1 + \frac{{u}_{3} {u}_{3}^{T}}{{u}_{3}^{0} + 1}\end{matrix} )$$

With the third Lorentz boost matrix B₃η thus given the Wigner rotation matrix ^{W}Rη can be calculated by resolving equ.(14) for the Wigner rotation matrix:

$${}^{W} R η = ( \begin{matrix}1 & {0}^{T} \\ 0 & {}^{W} R\end{matrix} ) = {\underbrace{{( {B}_{3} η )}^{- 1}}}_{{( {}^{A} L η )}^{- 1}} {\underbrace{( {B}_{1} η ) ( {B}_{2} η )}}_{{}^{B} L η} ⩵ {( \begin{matrix}{u}_{3}^{0} & {u}_{3}^{T} \\ {u}_{3} & {B}_{3}\end{matrix} )}^{- 1} ( \begin{matrix}{u}_{1}^{0} & {u}_{1}^{T} \\ {u}_{1} & {B}_{1}\end{matrix} ) ( \begin{matrix}{u}_{2}^{0} & {u}_{2}^{T} \\ {u}_{2} & {B}_{2}\end{matrix} ) ⩵ {( \begin{matrix}{u}_{3}^{0} & {u}_{3}^{T} \\ {u}_{3} & {B}_{3}\end{matrix} )}^{- 1} ( \begin{matrix}{u}_{1}^{0} {u}_{2}^{0} + {u}_{1}^{T} {u}_{2} & {u}_{1}^{0} {u}_{2}^{T} + {u}_{1}^{T} {B}_{2} \\ {u}_{2}^{0} {u}_{1} + {B}_{1} {u}_{2} & {u}_{1} {u}_{2}^{T} + {B}_{1} {B}_{2}\end{matrix} ) = \qquad ( 16 )$$

$$= {\underbrace{{( \begin{matrix}{u}_{3}^{0} & {u}_{3}^{T} \\ {u}_{3} & {B}_{3}\end{matrix} )}^{- 1}}}_{{( {}^{A} L η )}^{- 1}} {\underbrace{( \begin{matrix}{u}_{3}^{0} & {u}_{1}^{0} {u}_{2}^{T} + {u}_{1}^{T} {B}_{2} \\ {u}_{3} & {u}_{1} {u}_{2}^{T} + {B}_{1} {B}_{2}\end{matrix} )}}_{{}^{B} L η} \qquad ( 17 )$$

However this seemingly simple task turns out to be complex when done manually and was in fact considered to be prohibitively complex for decades ([9, abstract], [2, p. 58, 2nd para.]), such that other methods to determine the Wigner rotation angle ^{W} [symbol] and the Wigner rotation axis ^{W}\hat{ω} have been developed (see for [symbol] example [4, chapter “6.7.2 Thomas Rotation” on p. 206-211 and chapter “6.7.3 Thomas Rotation Angle” on p. 212-215, in particular the “Historical note” on p. 215], [10, in particular chapter “1. Introduction”], [8, p. 180], [9] and [11]).

With the Wigner angle ^{W} [symbol] and the rotation axis ^{W}\hat{ω} given the Wigner rotation matrix ^{W}R can also be brought in the following standard form using the Rodrigues formula [6, p. 393], which defines an arbitrary rotation matrix R in terms of the rotation angle [symbol] and the unit vector \hat{ω} pointing in the direction of the rotation axis:

$$R = {( sin ϑ ) [ \hat{ω} ]}_{\times } + 1 + ( 1 - cos ϑ ) {( {[ \hat{ω} ]}_{\times } )}^{2} = \qquad ( 18 )$$

$$= {\underbrace{{( sin ϑ ) [ \hat{ω} ]}_{\times }}}_{\frac{1}{2} ( R - {R}^{T} )} + {\underbrace{( 1 - cos ϑ ) \hat{ω} {\hat{ω}}^{T} + cos ϑ 1}}_{\frac{1}{2} ( R - {R}^{T} )} \qquad \text{(19)}$$

with the unit matrix 1 being defined in equ.(10) and with the skew symmetric matrix [\hat{ω}]ₓ being defined by

$${[ \hat{ω} ]}_{\times } := ( \begin{matrix}0 & - {\hat{ω}}_{3} & {\hat{ω}}_{2} \\ {\hat{ω}}_{3} & 0 & - {\hat{ω}}_{1} \\ - {\hat{ω}}_{2} & {\hat{ω}}_{1} & 0\end{matrix} ) {{⇒}^{{↓}^{[ 6 , fact 4.12 \text{.1} . i ) on p \text{.384} ]}} [ \hat{ω} ]}_{\times }^{2} = \hat{ω} {\hat{ω}}^{T} - 1$$

such that for any three dimensional vector a the following applies [6, fact 4.12.1. viii) on p. 384]:

[\hat{ω}]ₓ·a=\hat{ω}×a

Equ.(19) shows that an easy way to determine the rotation angle [symbol] and the rotation axis \hat{ω} of an arbitrary rotation matrix R is to determine the antisymmetric part

$$\frac{1}{2} ( R - {R}^{T} )$$

except if the antiymmetric part turns out to be equal to [0]ₓ. In the latter case the rotation angle is either [symbol] =0 and the rotation axis undetermined (and the rotation matrix the unity matrix R=1) or the rotation angle is [symbol] =π and

[symbol]

=π=R=2\hat{ω}\hat{ω}^{T}−1

such that the three components of the rotation axis \hat{ω} can in this case be determined as the three square roots of the three diagonal elements of the matrix

$$\frac{1}{2} ( R + 1 ) .$$

Equ.(19) shows further that another way to determine the rotation angle [symbol] of an arbitrary rotation matrix R is to evaluate the trace of the rotation matrix, which requires only the symmetric part:

$$tr R = tr [ \frac{1}{2} ( R + {R}^{T} ) ] = ( 1 - cos ϑ ) ( {\hat{ω}}_{1}^{2} + {\hat{ω}}_{2}^{2} + {\hat{ω}}_{3}^{2} ) + 3 cos ϑ = 1 + 2 cos ϑ \qquad ( 20 )$$

At least one of the first to determine the Wigner angle and the rotation axis by simply evaluating equ.(16) appears to be D. E. Fahnline [1, abstract and chapter “IV. DECOMPOSITION OF THE PRODUCT OF TWO PURE LORENTZ TRANSFORMATIONS”]. He tackled the problem using a covariant form of the Lorentz boost, which he introduced in said article and which has meanwhile found its way into at least one textbook ([8, chapter “15 The Covariant Lorentz Transformation”]; however the very same textbook derives the Wigner angle not by the method disclosed in [1], see [8, p. 180]). Fahnline obtains the 3-dimensional Wigner rotation matrix ^{W}R in the form of a linear combination of a unity matrix and three dyads ([1, equ.(30) on p. 820]) and illustrates the calculation path. Fahnline then uses equ.(20) above to determine the Wigner angle ^{W} [symbol] ([1, p. 821, first paragraph]). The eigenvector of the Wigner rotation matrix ^{W}R and thus the Wigner rotation axis ^{W}\hat{ω} can be directly read from the matrix due to its simple structure. Fahnline does not transform the Wigner rotation matrix ^{W}R in the Rodrigues form of equ.(18).

According to [2] Ungar derived the Wigner rotation matrix ^{W}R in the Rodrigues form of equ.(18) likewise by evaluating equ.(16), but provided only the final result ([2, equ.(14) on p. 63 and equ.(15a), (15b), (16) on p. 64 as well as equ.(4) on p. 61]) without giving intermediate results. Fahnline [1] is cited by Ungar [2, reference 2 on p. 87].

### SUMMARY OF THE INVENTION

The problem to be solved by this invention is to provide an alternative way to evaluate the right hand side of equ.(16). Instead of using the covariant form of the Lorentz boost as done by Fahnline we use a partitioned form of the Lorentz boost matrix. Moreover we use the four-velocity u=(u⁰ u)^{T} instead of the Lorentz factor γ and the speed v/c, which simplifies the notation.

The problem of determining the Wigner rotation matrix ^{W}R according to equ.(16) can be generalised in the following way: the first column vectors of the two Lorenz transformation matrices ^{A}Lη=B₃η and ^{B}Lη=(B₁η) (B₂η) defined in equ.(16) are identical as can be seen in equ.(17). The more general problem is thus to determine the rotation matrix Rη linking two restricted Lorentz transformation matrices ^{A}Lη and ^{B}Lη with identical first column vectors:

Rη=(^{A}Lη)^{-1B}Lη

This general problem is solved as defined in claim 1 by using matrix partitioning. Advantageous embodiments are defined in dependent claims 2-4.

### BRIEF DESCRIPTION OF THE DRAWINGS

Not Applicable

### DETAILED DESCRIPTION OF THE PREFERRED EMBODIMENTS

In Annex 2.1. (or equivalently in annex 2.2.) we show that any restricted Lorentz transformation matrix Lη can be partitioned in the following way:

$$L η = ( \begin{matrix}{u}^{0} & {( \frac{1}{{u}^{0}} {L}^{T} u )}^{T} \\ u & L\end{matrix} ) \qquad ( 21 )$$

$$with$$

$${LL}^{T} = 1 + {uu}^{T} ⇔ {L}^{- 1} = {L}^{T} ( 1 - \frac{{uu}^{T}}{{( {u}^{0} )}^{2}} ) \qquad ( 22 )$$

$$and$$

$$det L = {u}^{0} \qquad \text{(23)}$$

Note that from equ.(22) and det(1+uu^{T})=1+u² ([6, fact 3.21.1. on p. 351]) one can easily derive |det L|=u⁰, but only equ.(23) ensures that det(Lη)=1 (equ.(8) above) is fulfilled as shown in said annex 2.1. (and equivalently in annex 2.2). In annex 2.1. the three preceding equations are proven using equ.(6) above, while in annex 2.2. the three preceding equations are proven using equ.(13), i.e. annexes 2.1. and 2.2. are equivalent.

With this partitioned form it is easy to calculate the rotation matrix linking two restricted Lorentz transformation matrices with identical first column vector, i.e. with identical four-velocity:

$${}^{A} L η = ( \begin{matrix}{u}^{0} & {( \frac{1}{{u}^{0}} {}^{A} L {}^{T} u )}^{T} \\ u & {}^{A} L\end{matrix} ) and {}^{B} L η = ( \begin{matrix}{u}^{0} & {( \frac{1}{{u}^{0}} {}^{B} L {}^{T} u )}^{T} \\ u & {}^{B} L\end{matrix} ) \qquad ( 24 )$$

$$⇓$$

$${}^{B} L η = ( {}^{A} L η ) ( R η ) ⇔ ( \begin{matrix}{u}^{0} & {( \frac{1}{{u}^{0}} {}^{B} L {}^{T} u )}^{T} \\ u & {}^{B} L\end{matrix} ) = ( \begin{matrix}{u}^{0} & {( \frac{1}{{u}^{0}} {}^{A} L {}^{T} u )}^{T} \\ u & {}^{A} L\end{matrix} ) ( \begin{matrix}1 & 0 \\ 0 & R\end{matrix} ) = ( \begin{matrix}{u}^{0} & {( \frac{1}{{u}^{0}} {R}^{T} {}^{A} L {}^{T} u )}^{T} \\ u & {}^{A} LR\end{matrix} ) ⇒ {}^{B} L = {}^{A} LR ⇔ R = {}^{A} {L}^{- 1} {}^{B} L {=}^{{↓}^{equ . ( 40 )}} {}^{A} {L}^{T} ( 1 - \frac{1}{{( {u}^{0} )}^{2}} {uu}^{T} ) {}^{B} L$$

$$⇒ R η = ( \begin{matrix}1 & 0 \\ 0 & R\end{matrix} ) = {( {L}_{A} η )}^{- 1} {L}_{B} η ⩵ ( \begin{matrix}1 & {0}^{T} \\ 0 & {}^{A} {L}^{T} ( 1 - \frac{1}{{( {u}^{0} )}^{2}} {uu}^{T} ) {}^{B} L\end{matrix} ) {=}^{{↓}^{equ . ( 40 )}} ( \begin{matrix}1 & {0}^{T} \\ 0 & {}^{A} {L}^{- 1} {}^{B} L\end{matrix} ) \qquad ( 25 )$$

This formula and the simple structure of B (equ.(10)) simplify the calculation of the Wigner rotation matrix (Thomas rotation matrix) as shown in the following. From equ.(17), (24) and (25) follows

$${}^{W} R = {B}_{3}^{- 1} ( {u}_{1} {u}_{2}^{T} + {B}_{1} {B}_{2} ) = {=}^{{↓}^{equ . ( 12 )}} [ 1 - \frac{{u}_{3} {u}_{3}^{T}}{{u}_{3}^{0} ( {u}_{3}^{0} + 1 )} ] ( {u}_{1} {u}_{2}^{T} + {B}_{1} {B}_{2} ) = {=}^{{↓}^{equ . ( 15 )}} [ 1 - \frac{( {u}_{2}^{0} {u}_{1} + {B}_{1} {u}_{2} ) \cdot {( {u}_{2}^{0} {u}_{1} + {B}_{1} {u}_{2} )}^{T}}{( {u}_{1}^{0} {u}_{2}^{0} + {u}_{1}^{T} {u}_{2} ) ( {u}_{1}^{0} {u}_{2}^{0} + {u}_{1}^{T} {u}_{2} + 1 )} ] ( {u}_{1} {u}_{2}^{T} + {B}_{1} {B}_{2} ) = {=}^{{↓}^{equ . ( 10 )}} [ 1 - \frac{( {u}_{2}^{0} {u}_{1} + ( 1 + \frac{{u}_{1} {u}_{1}^{T}}{{u}_{1}^{0} + 1} ) {u}_{2} ) \cdot {( {u}_{2}^{0} {u}_{1} + ( 1 + \frac{{u}_{1} {u}_{1}^{T}}{{u}_{1}^{0} + 1} ) {u}_{2} )}^{T}}{( {u}_{1}^{0} {u}_{2}^{0} + {u}_{1}^{T} {u}_{2} ) ( {u}_{1}^{0} {u}_{2}^{0} + {u}_{1}^{T} {u}_{2} + 1 )} ] \cdot \cdot [ {u}_{1} {u}_{2}^{T} + ( 1 + \frac{{u}_{1} {u}_{1}^{T}}{{u}_{1}^{0} + 1} ) ( 1 + \frac{{u}_{2} {u}_{2}^{T}}{{u}_{2}^{0} + 1} ) ] = \qquad ( 26 )$$

$${=}^{{↓}^{annex 3}} 1 + {u}_{1} {u}_{1}^{T} \frac{1 - {u}_{2}^{0}}{( {u}_{1}^{0} + 1 ) ( {u}_{1}^{0} {u}_{2}^{0} + {u}_{1}^{T} {u}_{2} + 1 )} ++ {u}_{2} {u}_{2}^{T} \frac{1 - {u}_{1}^{0}}{( {u}_{2}^{0} + 1 ) ( {u}_{1}^{0} {u}_{2}^{0} + {u}_{1}^{T} {u}_{2} + 1 )} ++ {u}_{1} {u}_{2}^{T} \frac{2 {u}_{1}^{T} {u}_{2} + ( {u}_{1}^{0} + 1 ) ( {u}_{2}^{0} + 1 )}{( {u}_{1}^{0} + 1 ) ( {u}_{2}^{0} + 1 ) ( {u}_{1}^{0} {u}_{2}^{0} + {u}_{1}^{T} {u}_{2} + 1 )} + - {u}_{2} {u}_{1}^{T} \frac{1}{{u}_{1}^{0} {u}_{2}^{0} + {u}_{1}^{T} {u}_{2} + 1} = \qquad ( 27 )$$

$${=}^{{↓}^{annex 5}} 1 - {\frac{{u}_{1}^{0} + {u}_{2}^{0} + {\overbrace{{u}_{1}^{0} {u}_{2}^{0} + {u}_{1}^{T} {u}_{2}}}^{{u}_{3}^{0}} + 1}{( {u}_{1}^{0} + 1 ) ( {u}_{2}^{0} + 1 ) ( {\underbrace{{u}_{1}^{0} {u}_{2}^{0} + {u}_{1}^{T} {u}_{2}}}_{{u}_{3}^{0}} + 1 )} [ {u}_{1} \times {u}_{2} ]}_{\times } ++ {\frac{1}{( {u}_{1}^{0} + 1 ) ( {u}_{2}^{0} + 1 ) ( {\underbrace{{u}_{1}^{0} {u}_{2}^{0} + {u}_{1}^{T} {u}_{2}}}_{{u}_{3}^{0}} + 1 )} [ {u}_{1} \times {u}_{2} ]}_{\times }^{2} = \qquad ( 28 )$$

$${=}^{{↓}^{equ . ( 2 )}} 1 - {\frac{{γ}_{1} + {γ}_{2} + {\overbrace{{γ}_{1} {γ}_{2} + {γ}_{1} {γ}_{2} \frac{{v}_{1}^{T} {v}_{2}}{{c}^{2}}}}^{{γ}_{3}} + 1}{( {γ}_{1} + 1 ) ( {γ}_{2} + 1 ) ( {\underbrace{{γ}_{1} {γ}_{2} + {γ}_{1} {γ}_{2} \frac{{v}_{1}^{T} {v}_{2}}{{c}^{2}}}}_{{γ}_{3}} + 1 )} [ \frac{{γ}_{1} {v}_{1}}{c} \times \frac{{γ}_{2} {v}_{2}}{c} ]}_{\times } ++ {\frac{1}{( {γ}_{1} + 1 ) ( {γ}_{2} + 1 ) ( {\underbrace{{γ}_{1} {γ}_{2} + {γ}_{1} {γ}_{2} \frac{{v}_{1}^{T} {v}_{2}}{{c}^{2}}}}_{{γ}_{3}} + 1 )} [ \frac{{γ}_{1} {v}_{1}}{c} \times \frac{{γ}_{2} {v}_{2}}{c} ]}_{\times }^{2} \qquad ( 29 )$$

For the last step we used the relation

$${u}_{i} = ( \begin{matrix}{u}_{i}^{0} \\ {u}_{i}\end{matrix} ) = {γ}_{i} ( \begin{matrix}1 \\ \frac{{v}_{i}}{c}\end{matrix} )$$

for i=1, 2, 3 from equ.(2) above.

It is already apparent from equ.(26) that the expression for the Wigner rotation matrix is the sum of a unity matrix and a linear combination of dyads and thus has the general structure of equ.(27), but the calculation of the scalar factors associated with each dyad is lengthy as detailed in annex 3. However this calculation is straight forward and involves only school mathematics. Equ.(27) is the form in which the Wigner rotation matrix was derived by Fahnline [1, equ.(30) on p. 820] as detailed in annex 6. From this form it is already apparent that u₁×u₂ is a proper vector of the Wigner rotation matrix with proper value 1 and thus points into the direction of the axis of rotation ([1, p. 821, left col., penultimate paragraph]). Fahnline determined the Wigner rotation angle using equ.(20), i.e. using only the symmetric part of the Wigner rotation matrix ([1, p. 821, left col., first paragraph]). The transformation from equ.(27) to equ.(28) resides essentially in the separation of the Wigner rotation matrix into the symmetric and the antisymmetric part and in the use of the relation [u₁×u₂]ₓ=u₂u₁^{T}−u₁u₂^{T}[6, fact 4.12.1 xi) on p. 384] as detailed in annex 5. Finally in the form of equ.(29) the Wigner rotation matrix was derived by Ungar [2, equ.(4), (14), (15a), (15b), (16)].

Comparing equ.(28) with the standard Rodrigues form of a rotation in equ.(18) above yields the following expressions for the sine and the cosine of the Wigner rotation angle ^{W} [symbol] :

$$sin {}^{W} ϑ = - \frac{( {u}_{1}^{0} + {u}_{2}^{0} + {\overbrace{{u}_{1}^{0} {u}_{2}^{0} + {u}_{1}^{T} {u}_{2}}}^{{u}_{3}^{0}} + 1 ) \sqrt{{( {u}_{1} \times {u}_{2} )}^{2}}}{( {u}_{1}^{0} + 1 ) ( {u}_{2}^{0} + 1 ) ( {\underbrace{{u}_{1}^{0} {u}_{2}^{0} + {u}_{1}^{T} {u}_{2}}}_{{u}_{3}^{0}} + 1 )} \qquad ( 30 )$$

$$cos {}^{W} ϑ = 1 - \frac{{( {u}_{1} \times {u}_{2} )}^{2}}{( {u}_{1}^{0} + 1 ) ( {u}_{2}^{0} + 1 ) ( {\underbrace{{u}_{1}^{0} {u}_{2}^{0} + {u}_{1}^{T} {u}_{2}}}_{{u}_{3}^{0}} + 1 )} = \qquad ( 31 )$$

$${=}^{{↓}^{annex 7}} \frac{{( {u}_{1}^{0} + {u}_{2}^{0} + {\overbrace{{u}_{1}^{0} {u}_{2}^{0} + {u}_{1}^{T} {u}_{2}}}^{{u}_{3}^{0}} + 1 )}^{2}}{( {u}_{1}^{0} + 1 ) ( {u}_{2}^{0} + 1 ) ( {\underbrace{{u}_{1}^{0} {u}_{2}^{0} + {u}_{1}^{T} {u}_{2}}}_{{u}_{3}^{0}} + 1 )} - 1 \qquad ( 32 )$$

Equ.(30) is identical to the ‘Stapp formula’ ([4, equ.(6.118) on p. 214]) and equ.(32) is identical to equ.(6.115) on p. 213 of textbook [4]. In annex 8 it is shown that the identity cos^{2 W} [symbol] +sin^{2 W} [symbol] =1 holds.

The method to calculate the rotation matrix linking two restricted Lorentz transformation matrices with identical first column vector using equ.(24) as claimed in claim 1 can also be used to simplify the calculation of the rotation matrix linking to different local frames of the same timelike worldline, since the mixed tensor matrix, which is formed by using the four four-vectors of a local frame of a timelike worldline as column vectors, is a proper time T dependent Lorentz transformation matrix with the first column four-vector being formed by the four-velocity u(τ)=(u⁰(τ)u(τ))^{T} of the timelike worldline [4, chapter “3.4.1 Local Frame of an Observer” on pages 76-78] or [12, para. 0005-0010 on pages 3,4]. In particular two local frames for the same timelike worldline have the same first column four-vector, such that the method of claim 1 can be applied.

For example in [12, equ.(44) on p. 18 and equ.(53) on p. 22] two local frames L̆η, L̊η for the same timelike worldline with four-velocity u=(u⁰ u)^{T} and four acceleration

$$a = \frac{du}{d τ} = {( {a}^{0} a )}^{T}$$

(the explicit dependance on proper time τ is omitted for clarity) are defined as follows:

$${L}^{⌣} η := ( \begin{matrix}{u}^{0} & \frac{{a}^{0}}{\sqrt{{a}^{2}}} & - \frac{{( u \times a )}^{2}}{\sqrt{{{a}^{2} ( u \times a )}^{2}}} & 0 \\ u & \frac{a}{\sqrt{{a}^{2}}} & - \frac{( {u}^{0} a - {a}^{0} u ) \times ( u \times a )}{\sqrt{{{a}^{2} ( u \times a )}^{2}}} & \frac{u \times a}{\sqrt{{( u \times a )}^{2}}}\end{matrix} )$$

$$\mathring{L} η := ( \begin{matrix}{u}^{0} & \sqrt{{u}^{2}} & 0 & 0 \\ u & \frac{{u}^{0}}{\sqrt{{u}^{2}}} u & - \frac{u \times ( u \times a )}{\sqrt{{[ u \times ( u \times a ) ]}^{2}}} & \frac{u \times a}{\sqrt{{( u \times a )}^{2}}}\end{matrix} )$$

The rotation R̊η linking the two local frames is determined for a²≠0Λu²≠0 in [12, equ.(61) and (62) on p. 24 and annex 20 on p. 85-87] using 4×4-matrices as follows:

$$\mathring{R} η = {( \mathring{L} η )}^{- 1} {L}^{⌣} η = ( \begin{matrix}1 & {0}^{T} \\ 0 & \mathring{R} ( τ )\end{matrix} ) = ( \begin{matrix}1 & 0 & 0 & 0 \\ 0 & \frac{{a}^{0}}{\sqrt{{a}^{2}} \sqrt{{u}^{2}}} & - \frac{\sqrt{{( u \times a )}^{2}}}{\sqrt{{a}^{2}} \sqrt{{u}^{2}}} & 0 \\ 0 & \frac{\sqrt{{( u \times a )}^{2}}}{\sqrt{{a}^{2}} \sqrt{{u}^{2}}} & \frac{{a}^{0}}{\sqrt{{a}^{2}} \sqrt{{u}^{2}}} & 0 \\ 0 & 0 & 0 & 1\end{matrix} ) \qquad ( 33 )$$

This rotation matrix can easier be determined according to the invention as defined in claim 1 by using 3×3 matrices and equ.(24):

$$\mathring{R} η = ( \begin{matrix}1 & 0 \\ 0 & \mathring{R} ( τ )\end{matrix} ) = {( \mathring{L} η )}^{- 1} {L}^{⌣} η = {=}^{\begin{matrix}equ . ( 24 ) \\ ↓\end{matrix}} ( \begin{matrix}1 & {0}^{T} \\ 0 & \mathring{L} {}^{T} ( 1 - \frac{1}{{( {u}^{0} )}^{2}} {uu}^{T} ) {L}^{⌣}\end{matrix} ) \mathring{R} ( τ ) = \mathring{L} {}^{T} ( 1 - \frac{1}{{( {u}^{0} )}^{2}} {uu}^{T} ) {L}^{⌣} ⩵ {( \frac{{u}^{0}}{\sqrt{{u}^{2}}} u - \frac{u \times ( u \times a )}{\sqrt{{[ u \times ( u \times a ) ]}^{2}}} \frac{u \times a}{\sqrt{{( u \times a )}^{2}}} )}^{T} ( 1 - \frac{1}{{( {u}^{0} )}^{2}} {uu}^{T} ) \cdot \cdot ( \frac{a}{\sqrt{{a}^{2}}} - \frac{( {u}^{0} a - {a}^{0} u ) \times ( u \times a )}{\sqrt{{{a}^{2} ( u \times a )}^{2}}} \frac{u \times a}{\sqrt{{( u \times a )}^{2}}} ) = \qquad ( 34 )$$

$${=}^{\begin{matrix}annex 9 \\ ↓\end{matrix}} ( \begin{matrix}\frac{{a}^{0}}{\sqrt{{u}^{2}} \sqrt{{a}^{2}}} & - \frac{\sqrt{{( u \times a )}^{2}}}{\sqrt{{u}^{2}} \sqrt{{a}^{2}}} & 0 \\ \frac{\sqrt{{( u \times a )}^{2}}}{\sqrt{{u}^{2}} \sqrt{{a}^{2}}} & \frac{{a}^{0}}{\sqrt{{u}^{2}} \sqrt{{a}^{2}}} & 0 \\ 0 & 0 & 1\end{matrix} ) \qquad ( 35 )$$

This is the result obtained in [12] as shown in equ.(33) above. The remarks regarding the industrial applicability in annex 33 on p. 127 of [12], which is incorporated herein by reference, thus apply mutatis mutandis also to this application.

Annex 1

The relationship

$${( 1 + \frac{{uu}^{T}}{{u}^{0} + 1} )}^{- 1} = ( 1 - \frac{{uu}^{T}}{{u}^{0} ( {u}^{0} + 1 )} )$$

is proven as follows:

$$( 1 + \frac{{uu}^{T}}{{u}^{0} + 1} ) ( 1 - \frac{{uu}^{T}}{{u}^{0} ( {u}^{0} + 1 )} ) == 1 + \frac{{uu}^{T}}{{u}^{0} + 1} - \frac{{uu}^{T}}{{u}^{0} ( {u}^{0} + 1 )} - ( \frac{{uu}^{T}}{{u}^{0} + 1} ) ( \frac{{uu}^{T}}{{u}^{0} ( {u}^{0} + 1 )} ) ⩵ 1 + \frac{{uu}^{T}}{{u}^{0} + 1} - \frac{{uu}^{T}}{{u}^{0} ( {u}^{0} + 1 )} - \frac{{u}^{2} {uu}^{T}}{{{u}^{0} ( {u}^{0} + 1 )}^{2}} ⩵ 1 + \frac{{uu}^{T}}{{u}^{0} + 1} ( 1 - \frac{1}{{u}^{0}} - \frac{{u}^{2}}{{u}^{0} ( {u}^{0} + 1 )} ) ⩵ 1 + \frac{{uu}^{T}}{{u}^{0} + 1} \frac{{u}^{0} ( {u}^{0} + 1 ) - ( {u}^{0} + 1 ) - {u}^{2}}{{u}^{0} ( {u}^{0} + 1 )} ⩵ 1 + \frac{{uu}^{T}}{{u}^{0} + 1} \frac{{( {u}^{0} )}^{2} - 1 - {u}^{2}}{{u}^{0} ( {u}^{0} + 1 )} = 1 + \frac{{uu}^{T}}{{u}^{0} + 1} \frac{{( {u}^{0} )}^{2} - {( {u}^{0} )}^{2}}{{u}^{0} ( {u}^{0} + 1 )} = 1$$

Annex 2.1.

Since the four-velocity of a particle at rest is according to equ.(2) with v=0 equal to (1 0)^{T} and since a restricted Lorentz transformation must transform this to the four-velocity of equ.(2) with v=v, the first column vector of any restricted Lorentz transformation matrix must be the four-velocity. One can thus make the following general ansatz for an arbitrary restricted Lorentz transformation matrix:

$$L η = ( \begin{matrix}{u}^{0} & {w}^{T} \\ u & L\end{matrix} )$$

From condition (6) above follows

$${( L η )}^{- 1} = {η ( L η )}^{T} η = ( \begin{matrix}{u}^{0} & - {u}^{T} \\ - w & {L}^{T}\end{matrix} )$$

$$1 = L {η ( L η )}^{- 1} = ( \begin{matrix}{( {u}^{0} )}^{2} - {w}^{2} & - {( {u}^{0} u - Lw )}^{T} \\ {u}^{0} u - Lw & - {uu}^{T} + {LL}^{T}\end{matrix} )$$

$$⇓$$

$$1. {( {u}^{0} )}^{2} - {w}^{2} = 1 ⇔ {w}^{2} = {u}^{2} \qquad ( 36 )$$

$$2. {u}^{0} u - Lw = ( {u}^{0} \hat{u} - L \hat{w} ) \sqrt{{u}^{2}} = 0 ⇔ w = {u}^{0} {L}^{- 1} u \qquad \text{(37)}$$

$$3. - {uu}^{T} + {LL}^{T} = 1 ⇔ {L}^{- 1} = {{L}^{T} ( 1 + {uu}^{T} )}^{- 1} \qquad ( 38 )$$

$$[ 6 , fact ( 3.21 \text{.1} ) on p \text{.351} ] \to ⇔ {L}^{- 1} = {L}^{T} ( 1 - \frac{{uu}^{T}}{1 + {u}^{2}} ) \qquad ( 39 )$$

$$⇔ {L}^{- 1} = {L}^{T} ( 1 - \frac{{uu}^{T}}{{( {u}^{0} )}^{2}} ) \qquad ( 40 )$$

From equations (37) and (39) follows

$$w = {u}^{0} {L}^{- 1} u = {u}^{0} {L}^{T} ( 1 - \frac{{uu}^{T}}{1 + {u}^{2}} ) u ⩵ {u}^{0} {L}^{T} ( 1 - \frac{{u}^{2}}{1 + {u}^{2}} ) u = {u}^{0} {L}^{T} \frac{1}{{( {u}^{0} )}^{2}} u = \frac{1}{{u}^{0}} {L}^{T} u$$

According to textbook [6, equ.(3.9.11) on p. 303 and fact 3.17.2 on p. 334]

$$det ( L η ) = det ( \begin{matrix}{u}^{0} & {w}^{T} \\ u & L\end{matrix} ) = det ( L ) ( {u}^{0} - {w}^{T} {L}^{- 1} u ) == det ( L ) ( {u}^{0} - \frac{{w}^{T} {u}^{0} {L}^{- 1} u}{{u}^{0}} ) {=}^{\begin{matrix}equ . ( 37 ) \\ ↓\end{matrix}} = det ( L ) ( {u}^{0} - \frac{{w}^{T} w}{{u}^{0}} ) {=}^{\begin{matrix}equ . ( 36 ) \\ ↓\end{matrix}} \frac{det ( L )}{{u}^{0}} {=}^{\begin{matrix}equ . ( 8 ) \\ ↓\end{matrix}} 1 ⇒ det ( L ) = {u}^{0}$$

Annex 2.2.

Starting from the decomposition of equ.(13 one can derive

$$L η = ( B η ) ( R η ) = ( \begin{matrix}{u}^{0} & {u}^{T} \\ u & B\end{matrix} ) ( \begin{matrix}1 & {0}^{T} \\ 0 & R\end{matrix} ) = ( \begin{matrix}{u}^{0} & {u}^{T} R \\ u & BR\end{matrix} ) = …$$

For the further transformation we need the following relationship:

$${( \frac{1}{{u}^{0}} {( BR )}^{T} u )}^{T} = {( \frac{1}{{u}^{0}} {R}^{T} {B}^{T} u )}^{T} ⩵ {( \frac{1}{{u}^{0}} {R}^{T} {( 1 + \frac{{uu}^{T}}{{u}^{0} + 1} )}^{T} u )}^{T} = {( \frac{1}{{u}^{0}} {R}^{T} ( 1 + \frac{{uu}^{T}}{{u}^{0} + 1} ) u )}^{T} ⩵ {( \frac{1}{{u}^{0}} {R}^{T} ( 1 + \frac{{u}^{2}}{{u}^{0} + 1} ) u )}^{T} = ( \frac{1}{{u}^{0}} ( 1 + \frac{{u}^{2}}{{u}^{0} + 1} ) ) {u}^{T} R == \frac{{u}^{0} + 1 + {u}^{2}}{{u}^{0} ( {u}^{0} + 1 )} {u}^{T} R = ( \frac{{u}^{0} + {( {u}^{0} )}^{2}}{{u}^{0} ( {u}^{0} + 1 )} ) {u}^{T} R = {u}^{T} R$$

Now we can resume the transformation:

$$… = ( \begin{matrix}{u}^{0} & {( \frac{1}{{u}^{0}} {( BR )}^{T} u )}^{T} \\ u & BR\end{matrix} ) = ( \begin{matrix}{u}^{0} & {( \frac{1}{{u}^{0}} {L}^{T} u )}^{T} \\ u & L\end{matrix} )$$

Further the following applies:

$${LL}^{T} = {BR ( BR )}^{T} = {BRR}^{T} {B}^{T} = {B}^{2} = {( 1 + \frac{{uu}^{T}}{{u}^{0} + 1} )}^{2} ⩵ 1 + \frac{{uu}^{T}}{{u}^{0} + 1} + ( 1 + \frac{{uu}^{T}}{{u}^{0} + 1} ) \frac{{uu}^{T}}{{u}^{0} + 1} ⩵ 1 + \frac{{uu}^{T}}{{u}^{0} + 1} + ( 1 + \frac{{u}^{2}}{{u}^{0} + 1} ) \frac{{uu}^{T}}{{u}^{0} + 1} ⩵ 1 + ( 2 + \frac{{u}^{2}}{{u}^{0} + 1} ) \frac{{uu}^{T}}{{u}^{0} + 1} = 1 + ( \frac{2 {u}^{0} + 1 + 1 + {u}^{2}}{{u}^{0} + 1} ) \frac{{uu}^{T}}{{u}^{0} + 1} ⩵ 1 + ( \frac{2 {u}^{0} + 1 + {( {u}^{0} )}^{2}}{{u}^{0} + 1} ) \frac{{uu}^{T}}{{u}^{0} + 1} = 1 + {uu}^{T} ⇔ {L}^{- 1} = {L}^{T} ( 1 - \frac{{uu}^{T}}{{( {u}^{0} )}^{2}} )$$

$$and$$

$$det L = det ( BR ) = det B det R {=}^{\begin{matrix}equ . ( 9 ) \\ ↓\end{matrix}} det B ⩵ det ( 1 + \frac{{uu}^{T}}{{u}^{0} + 1} ) {=}^{\begin{matrix}[ 6 , fact ( 3.21 \text{.1} ) on p \text{.351} ] \\ ↓\end{matrix}} 1 + \frac{{u}^{2}}{{u}^{0} + 1} ⩵ \frac{{u}^{0} + 1 + {u}^{2}}{{u}^{0} + 1} = \frac{{u}^{0} + {( {u}^{0} )}^{2}}{{u}^{0} + 1} = {u}^{0}$$

Annex 3

This annex details the transformation of equ.(26) into equ.(27)

$$equ . ( 26 ) = [ 1 - \frac{( {u}_{2}^{0} {u}_{1} + ( 1 + \frac{{u}_{1} {u}_{1}^{T}}{{u}_{1}^{0} + 1} ) {u}_{2} ) \cdot {( {u}_{2}^{0} {u}_{1} + ( 1 + \frac{{u}_{1} {u}_{1}^{T}}{{u}_{1}^{0} + 1} ) {u}_{2} )}^{T}}{( {u}_{1}^{0} {u}_{2}^{0} + {u}_{1}^{T} {u}_{2} ) ( {u}_{1}^{0} {u}_{2}^{0} + {u}_{1}^{T} {u}_{2} + 1 )} ] \cdot \cdot \qquad \text{(41)}$$

$$[ {u}_{1} {u}_{2}^{T} + ( 1 + \frac{{u}_{1} {u}_{1}^{T}}{{u}_{1}^{0} + 1} ) ( 1 + \frac{{u}_{2} {u}_{2}^{T}}{{u}_{2}^{0} + 1} ) ] ⩵$$

$$[ 1 - \frac{[ ( {u}_{2}^{0} + \frac{{u}_{1}^{T} {u}_{2}}{{u}_{1}^{0} + 1} ) {u}_{1} + {u}_{2} ] \cdot {[ ( {u}_{2}^{0} + \frac{{u}_{1}^{T} {u}_{2}}{{u}_{1}^{0} + 1} ) {u}_{1} + {u}_{2} ]}^{T}}{( {u}_{1}^{0} {u}_{2}^{0} + {u}_{1}^{T} {u}_{2} ) ( {u}_{1}^{0} {u}_{2}^{0} + {u}_{1}^{T} {u}_{2} + 1 )} ] \cdot \cdot$$

$$[ 1 + \frac{{u}_{1} {u}_{1}^{T}}{{u}_{1}^{0} + 1} + \frac{{u}_{2} {u}_{2}^{T}}{{u}_{2}^{0} + 1} + ( 1 + \frac{( {u}_{1}^{T} {u}_{2} )}{( {u}_{1}^{0} + 1 ) ( {u}_{2}^{0} + 1 )} ) {u}_{1} {u}_{2}^{T} ] ⩵$$

$$[ 1 - \frac{1}{{( {u}_{1}^{0} + 1 )}^{2}} \cdot \cdot \frac{[ ( {u}_{2}^{0} + {u}_{2}^{0} {u}_{1}^{0} + {u}_{1}^{T} {u}_{2} ) {u}_{1} + ( {u}_{1}^{0} + 1 ) {u}_{2} ] \cdot {[ ( {u}_{2}^{0} + {u}_{2}^{0} {u}_{1}^{0} + {u}_{1}^{T} {u}_{2} ) {u}_{1} + ( {u}_{1}^{0} + 1 ) {u}_{2} ]}^{T}}{( {u}_{1}^{0} {u}_{2}^{0} + {u}_{1}^{T} {u}_{2} ) ( {u}_{1}^{0} {u}_{2}^{0} + {u}_{1}^{T} {u}_{2} + 1 )} ] \cdot \cdot$$

$$[ 1 + \frac{{u}_{1} {u}_{1}^{T}}{{u}_{1}^{0} + 1} + \frac{{u}_{2} {u}_{2}^{T}}{{u}_{2}^{0} + 1} + ( \frac{\begin{matrix}{u}_{1}^{0} {u}_{2}^{0} + {u}_{1}^{0} + \\ {u}_{2}^{0} + 1 + ( {u}_{1}^{T} {u}_{2} )\end{matrix}}{( {u}_{1}^{0} + 1 ) ( {u}_{2}^{0} + 1 )} ) {u}_{1} {u}_{2}^{T} ] = {=}^{{↓}^{{u}_{3}^{0} = {u}_{1}^{0} {u}_{2}^{0} + {u}_{1}^{T} {u}_{2} ( equ . ( 15 ) )}}$$

$$[ 1 - \frac{1}{{( {u}_{1}^{0} + 1 )}^{2}} \cdot \cdot \frac{[ ( {u}_{2}^{0} + {u}_{3}^{0} ) {u}_{1} + ( {u}_{1}^{0} + 1 ) {u}_{2} ] \cdot {[ ( {u}_{2}^{0} + {u}_{3}^{0} ) {u}_{1} + ( {u}_{1}^{0} + 1 ) {u}_{2} ]}^{T}}{{u}_{3}^{0} ( {u}_{3}^{0} + 1 )} ] \cdot \cdot$$

$$[ 1 + \frac{{u}_{1} {u}_{1}^{T}}{{u}_{1}^{0} + 1} + \frac{{u}_{2} {u}_{2}^{T}}{{u}_{2}^{0} + 1} + \frac{{u}_{3}^{0} + {u}_{1}^{0} + {u}_{2}^{0} + 1}{( {u}_{1}^{0} + 1 ) ( {u}_{2}^{0} + 1 )} {u}_{1} {u}_{2}^{T} ] ⩵$$

$$1 - \frac{1}{{( {u}_{1}^{0} + 1 )}^{2}} \frac{[ ( {u}_{2}^{0} + {u}_{3}^{0} ) {u}_{1} + ( {u}_{1}^{0} + 1 ) {u}_{2} ] \cdot {[ ( {u}_{2}^{0} + {u}_{3}^{0} ) {u}_{1} + ( {u}_{1}^{0} + 1 ) {u}_{2} ]}^{T}}{{u}_{3}^{0} ( {u}_{3}^{0} + 1 )} ++$$

$$[ 1 - \frac{1}{{( {u}_{1}^{0} + 1 )}^{2}} \frac{[ ( {u}_{2}^{0} + {u}_{3}^{0} ) {u}_{1} + ( {u}_{1}^{0} + 1 ) {u}_{2} ] \cdot {[ ( {u}_{2}^{0} + {u}_{3}^{0} ) {u}_{1} + ( {u}_{1}^{0} + 1 ) {u}_{2} ]}^{T}}{{u}_{3}^{0} ( {u}_{3}^{0} + 1 )} ] \cdot \cdot$$

$$\frac{{u}_{1} {u}_{1}^{T}}{{u}_{1}^{0} + 1} ++ [ 1 - \frac{1}{{( {u}_{1}^{0} + 1 )}^{2}} \frac{[ ( {u}_{2}^{0} + {u}_{3}^{0} ) {u}_{1} + ( {u}_{1}^{0} + 1 ) {u}_{2} ] \cdot {[ ( {u}_{2}^{0} + {u}_{3}^{0} ) {u}_{1} + ( {u}_{1}^{0} + 1 ) {u}_{2} ]}^{T}}{{u}_{3}^{0} ( {u}_{3}^{0} + 1 )} ] \cdot \cdot$$

$$\frac{{u}_{2} {u}_{2}^{T}}{{u}_{2}^{0} + 1} ++ [ 1 - \frac{1}{{( {u}_{1}^{0} + 1 )}^{2}} \frac{[ ( {u}_{2}^{0} + {u}_{3}^{0} ) {u}_{1} + ( {u}_{1}^{0} + 1 ) {u}_{2} ] \cdot {[ ( {u}_{2}^{0} + {u}_{3}^{0} ) {u}_{1} + ( {u}_{1}^{0} + 1 ) {u}_{2} ]}^{T}}{{u}_{3}^{0} ( {u}_{3}^{0} + 1 )} ] \cdot \cdot$$

$$\frac{{u}_{3}^{0} + {u}_{1}^{0} + {u}_{2}^{0} + 1}{( {u}_{1}^{0} + 1 ) ( {u}_{2}^{0} + 1 )} {u}_{1} {u}_{2}^{T} ⩵ 1 - \frac{{u}_{2}^{0} + {u}_{3}^{0}}{{( {u}_{1}^{0} + 1 )}^{2}} \frac{( {u}_{2}^{0} + {u}_{3}^{0} ) {u}_{1} {u}_{1}^{T} + ( {u}_{1}^{0} + 1 ) {u}_{2} {u}_{1}^{T}}{{u}_{3}^{0} ( {u}_{3}^{0} + 1 )} + -$$

$$\frac{1}{{u}_{1}^{0} + 1} \frac{( {u}_{2}^{0} + {u}_{3}^{0} ) {u}_{1} {u}_{2}^{T} + ( {u}_{1}^{0} + 1 ) {u}_{2} {u}_{2}^{T}}{{u}_{3}^{0} ( {u}_{3}^{0} + 1 )} ++$$

$$[ {u}_{1} {u}_{1}^{T} - \frac{1}{{( {u}_{1}^{0} + 1 )}^{2}} \cdot \cdot \frac{\begin{matrix}[ ( {u}_{2}^{0} + {u}_{3}^{0} ) {u}_{1} {u}_{1}^{T} + ( {u}_{1}^{0} + 1 ) {u}_{2} {u}_{1}^{T} ] \cdot \\ [ ( {u}_{2}^{0} + {u}_{3}^{0} ) {u}_{1}^{T} {u}_{1} + ( {u}_{1}^{0} + 1 ) {u}_{2}^{T} {u}_{1} ]\end{matrix}}{{u}_{3}^{0} ( {u}_{3}^{0} + 1 )} ] \cdot \frac{1}{{u}_{1}^{0} + 1} ++$$

$$[ {u}_{2} {u}_{2}^{T} - \frac{1}{{( {u}_{1}^{0} + 1 )}^{2}} \cdot \cdot \frac{\begin{matrix}[ ( {u}_{2}^{0} + {u}_{3}^{0} ) {u}_{1} {u}_{2}^{T} + ( {u}_{1}^{0} + 1 ) {u}_{2} {u}_{2}^{T} ] \cdot \\ [ ( {u}_{2}^{0} + {u}_{3}^{0} ) {u}_{1}^{T} {u}_{2} + ( {u}_{1}^{0} + 1 ) {u}_{2}^{T} {u}_{2} ]\end{matrix}}{{u}_{3}^{0} ( {u}_{3}^{0} + 1 )} ] \cdot \frac{1}{{u}_{2}^{0} + 1} ++$$

$$[ {u}_{1} {u}_{2}^{T} - \frac{1}{{( {u}_{1}^{0} + 1 )}^{2}} \cdot \cdot \frac{\begin{matrix}[ ( {u}_{2}^{0} + {u}_{3}^{0} ) {u}_{1} {u}_{2}^{T} + ( {u}_{1}^{0} + 1 ) {u}_{2} {u}_{2}^{T} ] \cdot \\ [ ( {u}_{2}^{0} + {u}_{3}^{0} ) {u}_{1}^{T} {u}_{1} + ( {u}_{1}^{0} + 1 ) {u}_{2}^{T} {u}_{1} ]\end{matrix}}{{u}_{3}^{0} ( {u}_{3}^{0} + 1 )} ] \cdot \cdot$$

$$\frac{{u}_{3}^{0} + {u}_{1}^{0} + {u}_{2}^{0} + 1}{( {u}_{1}^{0} + 1 ) + ( {u}_{2}^{0} + 1 )} ⩵ 1 - \frac{{u}_{2}^{0} + {u}_{3}^{0}}{{( {u}_{1}^{0} + 1 )}^{2}} \frac{( {u}_{2}^{0} + {u}_{3}^{0} ) {u}_{1} {u}_{1}^{T} + ( {u}_{1}^{0} + 1 ) {u}_{2} {u}_{1}^{T}}{{u}_{3}^{0} ( {u}_{3}^{0} + 1 )} + -$$

$$\frac{1}{{u}_{1}^{0} + 1} \frac{( {u}_{2}^{0} + {u}_{3}^{0} ) {u}_{1} {u}_{2}^{T} + ( {u}_{1}^{0} + 1 ) {u}_{2} {u}_{2}^{T}}{{u}_{3}^{0} ( {u}_{3}^{0} + 1 )} ++$$

$$[ {u}_{1} {u}_{1}^{T} + - \frac{\begin{matrix}[ ( {u}_{2}^{0} + {u}_{3}^{0} ) {u}_{1} {u}_{1}^{T} + ( {u}_{1}^{0} + 1 ) {u}_{2} {u}_{1}^{T} ] \cdot \\ [ ( {u}_{2}^{0} + {u}_{3}^{0} ) [ {( {u}_{1}^{0} )}^{2} - 1 ] + ( {u}_{1}^{0} + 1 ) {u}_{2}^{T} {u}_{1} ]\end{matrix}}{{( {u}_{1}^{0} + 1 )}^{2} {u}_{3}^{0} ( {u}_{3}^{0} + 1 )} ] \cdot \cdot \frac{1}{{u}_{1}^{0} + 1} ++$$

$$[ {u}_{2} {u}_{2}^{T} + - \frac{\begin{matrix}[ ( {u}_{2}^{0} + {u}_{3}^{0} ) {u}_{1} {u}_{2}^{T} + ( {u}_{1}^{0} + 1 ) {u}_{2} {u}_{2}^{T} ] \cdot \\ [ ( {u}_{2}^{0} + {u}_{3}^{0} ) {u}_{1}^{T} {u}_{2} + ( {u}_{1}^{0} + 1 ) [ {( {u}_{2}^{0} )}^{2} - 1 ]\end{matrix}}{{( {u}_{1}^{0} + 1 )}^{2} {u}_{3}^{0} ( {u}_{3}^{0} + 1 )} ] \cdot \cdot \frac{1}{{u}_{2}^{0} + 1} ++$$

$$[ {u}_{1} {u}_{2}^{T} + - \frac{\begin{matrix}[ ( {u}_{2}^{0} + {u}_{3}^{0} ) {u}_{1} {u}_{2}^{T} + ( {u}_{1}^{0} + 1 ) {u}_{2} {u}_{2}^{T} ] \cdot \\ [ ( {u}_{2}^{0} + {u}_{3}^{0} ) [ {( {u}_{1}^{0} )}^{2} - 1 ] + ( {u}_{1}^{0} + 1 ) {u}_{2}^{T} {u}_{1} ]\end{matrix}}{{( {u}_{1}^{0} + 1 )}^{2} {u}_{3}^{0} ( {u}_{3}^{0} + 1 )} ] \cdot \cdot \frac{{u}_{3}^{0} + {u}_{1}^{0} + {u}_{2}^{0} + 1}{( {u}_{1}^{0} + 1 ) + ( {u}_{2}^{0} + 1 )} ⩵$$

$$1 - \frac{{u}_{2}^{0} + {u}_{3}^{0}}{{( {u}_{1}^{0} + 1 )}^{2}} \frac{( {u}_{2}^{0} + {u}_{3}^{0} ) {u}_{1} {u}_{1}^{T} + ( {u}_{1}^{0} + 1 ) {u}_{2} {u}_{1}^{T}}{{u}_{3}^{0} ( {u}_{3}^{0} + 1 )} + -$$

$$\frac{1}{{u}_{1}^{0} + 1} \frac{( {u}_{2}^{0} + {u}_{3}^{0} ) {u}_{1} {u}_{2}^{T} + ( {u}_{1}^{0} + 1 ) {u}_{2} {u}_{2}^{T}}{{u}_{3}^{0} ( {u}_{3}^{0} + 1 )} ++$$

$$[ {u}_{1} {u}_{1}^{T} - \frac{\begin{matrix}[ ( {u}_{2}^{0} + {u}_{3}^{0} ) {u}_{1} {u}_{1}^{T} + ( {u}_{1}^{0} + 1 ) {u}_{2} {u}_{1}^{T} ] \cdot \\ [ ( {u}_{2}^{0} + {u}_{3}^{0} ) ( {u}_{1}^{0} - 1 ) + {u}_{2}^{T} {u}_{1} ]\end{matrix}}{( {u}_{1}^{0} + 1 ) {u}_{3}^{0} ( {u}_{3}^{0} + 1 )} ] \cdot \frac{1}{{u}_{1}^{0} + 1} ++$$

$$[ {u}_{2} {u}_{2}^{T} - [ \begin{matrix}( {u}_{2}^{0} + {u}_{3}^{0} ) {u}_{1} {u}_{2}^{T} + \\ ( {u}_{1}^{0} + 1 ) {u}_{2} {u}_{2}^{T}\end{matrix} ] \cdot \cdot \frac{[ \begin{matrix}( {u}_{2}^{0} + {u}_{3}^{0} ) ( {u}_{1}^{T} {u}_{2} + {u}_{1}^{0} {u}_{2}^{0} - {u}_{1}^{0} {u}_{2}^{0} ) + \\ ( {u}_{1}^{0} + 1 ) [ {( {u}_{2}^{0} )}^{2} - 1 ]\end{matrix} ]}{{( {u}_{1}^{0} + 1 )}^{2} {u}_{3}^{0} ( {u}_{3}^{0} + 1 )} ] \cdot$$

$$\frac{1}{{u}_{2}^{0} + 1} ++ [ {u}_{1} {u}_{2}^{T} - \frac{\begin{matrix}[ ( {u}_{2}^{0} + {u}_{3}^{0} ) {u}_{1} {u}_{2}^{T} + ( {u}_{1}^{0} + 1 ) {u}_{2} {u}_{2}^{T} ] \cdot \\ [ ( {u}_{2}^{0} + {u}_{3}^{0} ) ( {u}_{1}^{0} - 1 ) + {u}_{2}^{T} {u}_{1} ]\end{matrix}}{( {u}_{1}^{0} + 1 ) {u}_{3}^{0} ( {u}_{3}^{0} + 1 )} ] \cdot \cdot$$

$$\frac{{u}_{3}^{0} + {u}_{1}^{0} + {u}_{2}^{0} + 1}{( {u}_{1}^{0} + 1 ) + ( {u}_{2}^{0} + 1 )} ⩵ 1 - \frac{{u}_{2}^{0} + {u}_{3}^{0}}{{( {u}_{1}^{0} + 1 )}^{2}} \frac{( {u}_{2}^{0} + {u}_{3}^{0} ) {u}_{1} {u}_{1}^{T} + ( {u}_{1}^{0} + 1 ) {u}_{2} {u}_{1}^{T}}{{u}_{3}^{0} ( {u}_{3}^{0} + 1 )} + -$$

$$\frac{1}{{u}_{1}^{0} + 1} \frac{( {u}_{2}^{0} + {u}_{3}^{0} ) {u}_{1} {u}_{2}^{T} + ( {u}_{1}^{0} + 1 ) {u}_{2} {u}_{2}^{T}}{{u}_{3}^{0} ( {u}_{3}^{0} + 1 )} ++$$

$$[ {u}_{1} {u}_{1}^{T} - \frac{\begin{matrix}[ ( {u}_{2}^{0} + {u}_{3}^{0} ) {u}_{1} {u}_{1}^{T} + ( {u}_{1}^{0} + 1 ) {u}_{2} {u}_{1}^{T} ] \cdot \\ [ {u}_{2}^{0} {u}_{1}^{0} + {u}_{3}^{0} {u}_{1}^{0} - {u}_{2}^{0} - {u}_{3}^{0} + {u}_{2}^{T} {u}_{1} ]\end{matrix}}{( {u}_{1}^{0} + 1 ) {u}_{3}^{0} ( {u}_{3}^{0} + 1 )} ] \cdot \cdot \frac{1}{{u}_{1}^{0} + 1} ++$$

$$[ {u}_{2} {u}_{2}^{T} - [ \begin{matrix}( {u}_{2}^{0} + {u}_{3}^{0} ) {u}_{1} {u}_{2}^{T} + \\ ( {u}_{1}^{0} + 1 ) {u}_{2} {u}_{2}^{T}\end{matrix} ] \cdot \cdot \frac{[ \begin{matrix}( {u}_{2}^{0} + {u}_{3}^{0} ) ( {u}_{1}^{T} {u}_{2} + {u}_{1}^{0} {u}_{2}^{0} - {u}_{1}^{0} {u}_{2}^{0} ) + \\ ( {u}_{1}^{0} + 1 ) ) [ {( {u}_{2}^{0} )}^{2} - 1 ]\end{matrix} ]}{{( {u}_{1}^{0} + 1 )}^{2} {u}_{3}^{0} ( {u}_{3}^{0} + 1 )} ] \cdot$$

$$\frac{1}{{u}_{2}^{0} + 1} ++ [ {u}_{1} {u}_{2}^{T} - \frac{\begin{matrix}[ ( {u}_{2}^{0} + {u}_{3}^{0} ) {u}_{1} {u}_{2}^{T} + ( {u}_{1}^{0} + 1 ) {u}_{2} {u}_{2}^{T} ] \cdot \\ [ {u}_{2}^{0} {u}_{1}^{0} + {u}_{3}^{0} {u}_{1}^{0} - {u}_{2}^{0} - {u}_{3}^{0} + {u}_{2}^{T} {u}_{1} ]\end{matrix}}{( {u}_{1}^{0} + 1 ) {u}_{3}^{0} ( {u}_{3}^{0} + 1 )} ] \cdot \cdot$$

$$\frac{{u}_{3}^{0} + {u}_{1}^{0} + {u}_{2}^{0} + 1}{( {u}_{1}^{0} + 1 ) + ( {u}_{2}^{0} + 1 )} ⩵ 1 - \frac{{u}_{2}^{0} + {u}_{3}^{0}}{{( {u}_{1}^{0} + 1 )}^{2}} \frac{( {u}_{2}^{0} + {u}_{3}^{0} ) {u}_{1} {u}_{1}^{T} + ( {u}_{1}^{0} + 1 ) {u}_{2} {u}_{1}^{T}}{{u}_{3}^{0} ( {u}_{3}^{0} + 1 )} + -$$

$$\frac{1}{{u}_{1}^{0} + 1} \frac{( {u}_{2}^{0} + {u}_{3}^{0} ) {u}_{1} {u}_{2}^{T} + ( {u}_{1}^{0} + 1 ) {u}_{2} {u}_{2}^{T}}{{u}_{3}^{0} ( {u}_{3}^{0} + 1 )} ++$$

$$[ {u}_{1} {u}_{1}^{T} - \frac{\begin{matrix}[ ( {u}_{2}^{0} + {u}_{3}^{0} ) {u}_{1} {u}_{1}^{T} + ( {u}_{1}^{0} + 1 ) {u}_{2} {u}_{1}^{T} ] \cdot \\ [ {u}_{3}^{0} + {u}_{3}^{0} {u}_{1}^{0} - {u}_{2}^{0} - {u}_{3}^{0} ]\end{matrix}}{( {u}_{1}^{0} + 1 ) {u}_{3}^{0} ( {u}_{3}^{0} + 1 )} ] \cdot \frac{1}{{u}_{1}^{0} + 1} ++$$

$$[ {u}_{2} {u}_{2}^{T} - [ \begin{matrix}( {u}_{2}^{0} + {u}_{3}^{0} ) {u}_{1} {u}_{2}^{T} + \\ ( {u}_{1}^{0} + 1 ) {u}_{2} {u}_{2}^{T}\end{matrix} ] \cdot \cdot \frac{[ \begin{matrix}( {u}_{2}^{0} + {u}_{3}^{0} ) ( {u}_{3}^{0} - {u}_{1}^{0} {u}_{2}^{0} ) + \\ ( {u}_{1}^{0} + 1 ) [ {( {u}_{2}^{0} )}^{2} - 1 ]\end{matrix} ]}{{( {u}_{1}^{0} + 1 )}^{2} {u}_{3}^{0} ( {u}_{3}^{0} + 1 )} ] \cdot \frac{1}{{u}_{2}^{0} + 1} ++$$

$$[ {u}_{1} {u}_{2}^{T} - \frac{\begin{matrix}[ ( {u}_{2}^{0} + {u}_{3}^{0} ) {u}_{1} {u}_{2}^{T} + ( {u}_{1}^{0} + 1 ) {u}_{2} {u}_{2}^{T} ] \cdot \\ [ {u}_{3}^{0} + {u}_{3}^{0} {u}_{1}^{0} - {u}_{2}^{0} - {u}_{3}^{0} ]\end{matrix}}{( {u}_{1}^{0} + 1 ) {u}_{3}^{0} ( {u}_{3}^{0} + 1 )} ] \cdot \cdot \frac{{u}_{3}^{0} + {u}_{1}^{0} + {u}_{2}^{0} + 1}{( {u}_{1}^{0} + 1 ) + ( {u}_{2}^{0} + 1 )} ⩵$$

$$1 - \frac{{u}_{2}^{0} + {u}_{3}^{0}}{{( {u}_{1}^{0} + 1 )}^{2}} \frac{( {u}_{2}^{0} + {u}_{3}^{0} ) {u}_{1} {u}_{1}^{T} + ( {u}_{1}^{0} + 1 ) {u}_{2} {u}_{1}^{T}}{{u}_{3}^{0} ( {u}_{3}^{0} + 1 )} + -$$

$$\frac{1}{{u}_{1}^{0} + 1} \frac{( {u}_{2}^{0} + {u}_{3}^{0} ) {u}_{1} {u}_{2}^{T} + ( {u}_{1}^{0} + 1 ) {u}_{2} {u}_{2}^{T}}{{u}_{3}^{0} ( {u}_{3}^{0} + 1 )} ++$$

$$[ {u}_{1} {u}_{1}^{T} - \frac{[ ( {u}_{2}^{0} + {u}_{3}^{0} ) {u}_{1} {u}_{1}^{T} + ( {u}_{1}^{0} + 1 ) {u}_{2} {u}_{1}^{T} ] \cdot ( {u}_{3}^{0} {u}_{1}^{0} - {u}_{2}^{0} )}{( {u}_{1}^{0} + 1 ) {u}_{3}^{0} ( {u}_{3}^{0} + 1 )} ] \cdot \frac{1}{{u}_{1}^{0} + 1} ++$$

$$[ {u}_{2} {u}_{2}^{T} - [ \begin{matrix}( {u}_{2}^{0} + {u}_{3}^{0} ) {u}_{1} {u}_{2}^{T} + \\ ( {u}_{1}^{0} + 1 ) {u}_{2} {u}_{2}^{T}\end{matrix} ] \cdot \cdot \frac{[ \begin{matrix}{u}_{2}^{0} ( {u}_{3}^{0} - {u}_{1}^{0} {u}_{2}^{0} ) + {u}_{3}^{0} ( {u}_{3}^{0} - {u}_{1}^{0} {u}_{2}^{0} ) + \\ ( {u}_{1}^{0} + 1 ) [ {( {u}_{2}^{0} )}^{2} - 1 ]\end{matrix} ]}{{( {u}_{1}^{0} + 1 )}^{2} {u}_{3}^{0} ( {u}_{3}^{0} + 1 )} ] \cdot$$

$$\frac{1}{{u}_{2}^{0} + 1} ++ [ {u}_{1} {u}_{2}^{T} - \frac{[ ( {u}_{2}^{0} + {u}_{3}^{0} ) {u}_{1} {u}_{2}^{T} + ( {u}_{1}^{0} + 1 ) {u}_{2} {u}_{2}^{T} ] \cdot ( {u}_{3}^{0} {u}_{1}^{0} - {u}_{2}^{0} )}{( {u}_{1}^{0} + 1 ) {u}_{3}^{0} ( {u}_{3}^{0} + 1 )} ] \cdot \cdot$$

$$\frac{{u}_{3}^{0} + {u}_{1}^{0} + {u}_{2}^{0} + 1}{( {u}_{1}^{0} + 1 ) + ( {u}_{2}^{0} + 1 )} ⩵ 1 - \frac{{u}_{2}^{0} + {u}_{3}^{0}}{{( {u}_{1}^{0} + 1 )}^{2}} \frac{( {u}_{2}^{0} + {u}_{3}^{0} ) {u}_{1} {u}_{1}^{T} + ( {u}_{1}^{0} + 1 ) {u}_{2} {u}_{1}^{T}}{{u}_{3}^{0} ( {u}_{3}^{0} + 1 )} + -$$

$$\frac{1}{{u}_{1}^{0} + 1} \frac{( {u}_{2}^{0} + {u}_{3}^{0} ) {u}_{1} {u}_{2}^{T} + ( {u}_{1}^{0} + 1 ) {u}_{2} {u}_{2}^{T}}{{u}_{3}^{0} ( {u}_{3}^{0} + 1 )} ++$$

$$[ {u}_{1} {u}_{1}^{T} - \frac{[ ( {u}_{2}^{0} + {u}_{3}^{0} ) {u}_{1} {u}_{1}^{T} + ( {u}_{1}^{0} + 1 ) {u}_{2} {u}_{1}^{T} ] \cdot ( {u}_{3}^{0} {u}_{1}^{0} - {u}_{2}^{0} )}{( {u}_{1}^{0} + 1 ) {u}_{3}^{0} ( {u}_{3}^{0} + 1 )} ] \cdot \frac{1}{{u}_{1}^{0} + 1} ++$$

$$[ {u}_{2} {u}_{2}^{T} - [ \begin{matrix}( {u}_{2}^{0} + {u}_{3}^{0} ) {u}_{1} {u}_{2}^{T} + \\ ( {u}_{1}^{0} + 1 ) {u}_{2} {u}_{2}^{T}\end{matrix} ] \cdot \cdot \frac{[ {u}_{3}^{0} ( {u}_{2}^{0} + {u}_{3}^{0} - {u}_{1}^{0} {u}_{2}^{0} ) + {( {u}_{2}^{0} )}^{2} - {u}_{1}^{0} - 1 ]}{{( {u}_{1}^{0} + 1 )}^{2} {u}_{3}^{0} ( {u}_{3}^{0} + 1 )} ] \cdot$$

$$\frac{1}{{u}_{2}^{0} + 1} ++ [ {u}_{1} {u}_{2}^{T} - \frac{[ ( {u}_{2}^{0} + {u}_{3}^{0} ) {u}_{1} {u}_{2}^{T} + ( {u}_{1}^{0} + 1 ) {u}_{2} {u}_{2}^{T} ] \cdot ( {u}_{3}^{0} {u}_{1}^{0} - {u}_{2}^{0} )}{( {u}_{1}^{0} + 1 ) {u}_{3}^{0} ( {u}_{3}^{0} + 1 )} ] \cdot \cdot$$

$$\frac{{u}_{3}^{0} + {u}_{1}^{0} + {u}_{2}^{0} + 1}{( {u}_{1}^{0} + 1 ) + ( {u}_{2}^{0} + 1 )} ⩵$$

$$1 ++ {u}_{1} {u}_{1}^{T} \{ - \frac{{( {u}_{2}^{0} + {u}_{3}^{0} )}^{2}}{{( {u}_{1}^{0} + 1 )}^{2} {u}_{3}^{0} ( {u}_{3}^{0} + 1 )} + \frac{1}{{u}_{1}^{0} + 1} - \frac{( {u}_{2}^{0} + {u}_{3}^{0} ) ( {u}_{3}^{0} {u}_{1}^{0} - {u}_{2}^{0} )}{{( {u}_{1}^{0} + 1 )}^{2} {u}_{3}^{0} ( {u}_{3}^{0} + 1 )} \} ++$$

$${u}_{2} {u}_{2}^{T} \{ \begin{matrix}- \frac{1}{{u}_{3}^{0} ( {u}_{3}^{0} + 1 )} + \frac{1}{{u}_{2}^{0} + 1} - \frac{{u}_{3}^{0} ( {u}_{2}^{0} + {u}_{3}^{0} - {u}_{1}^{0} {u}_{2}^{0} ) + {( {u}_{2}^{0} )}^{2} - {u}_{1}^{0} - 1}{( {u}_{2}^{0} + 1 ) ( {u}_{1}^{0} + 1 ) {u}_{3}^{0} ( {u}_{3}^{0} + 1 )} + - \\ \frac{( {u}_{3}^{0} {u}_{1}^{0} - {u}_{2}^{0} )}{{u}_{3}^{0} ( {u}_{3}^{0} + 1 )} \frac{( {u}_{3}^{0} + {u}_{1}^{0} + {u}_{2}^{0} + 1 )}{( {u}_{1}^{0} + 1 ) ( {u}_{2}^{0} + 1 )}\end{matrix} \} ++$$

$${u}_{1} {u}_{2}^{T} \{ \begin{matrix}- \frac{{u}_{2}^{0} + {u}_{3}^{0}}{{u}_{3}^{0} ( {u}_{3}^{0} + 1 ) ( {u}_{1}^{0} + 1 )} - \frac{\begin{matrix}( {u}_{2}^{0} + {u}_{3}^{0} ) \cdot [ {u}_{3}^{0} ( {u}_{2}^{0} + {u}_{3}^{0} - {u}_{1}^{0} {u}_{2}^{0} ) + \\ {( {u}_{2}^{0} )}^{2} - {u}_{1}^{0} - 1 ]\end{matrix}}{( {u}_{2}^{0} + 1 ) ( {u}_{1}^{0} + 1 ) {u}_{3}^{0} ( {u}_{3}^{0} + 1 )} ++ \\ \frac{{u}_{3}^{0} + {u}_{1}^{0} + {u}_{2}^{0} + 1}{( {u}_{1}^{0} + 1 ) ( {u}_{2}^{0} + 1 )} [ 1 - \frac{( {u}_{2}^{0} + {u}_{3}^{0} ) \cdot ( {u}_{3}^{0} {u}_{1}^{0} - {u}_{2}^{0} )}{( {u}_{1}^{0} + 1 ) {u}_{3}^{0} ( {u}_{3}^{0} + 1 )} ]\end{matrix} \} ++$$

$${u}_{2} {u}_{1}^{T} \{ - \frac{{u}_{2}^{0} + {u}_{3}^{0}}{{( {u}_{1}^{0} + 1 )}^{2}} \frac{{u}_{1}^{0} + 1}{{u}_{3}^{0} ( {u}_{3}^{0} + 1 )} - \frac{( {u}_{1}^{0} + 1 ) ( {u}_{3}^{0} {u}_{1}^{0} - {u}_{2}^{0}}{{( {u}_{1}^{0} + 1 )}^{2} {u}_{3}^{0} ( {u}_{3}^{0} + 1 )} \} =$$

$${=}^{{↓}^{annex 4}} 1 ++ {u}_{1} {u}_{1}^{T} \frac{1 - {u}_{2}^{0}}{( {u}_{1}^{0} + 1 ) ( {u}_{1}^{0} {u}_{2}^{0} + {u}_{1}^{T} {u}_{2} + 1 )} ++ {u}_{2} {u}_{2}^{T} \frac{1 - {u}_{1}^{0}}{( {u}_{2}^{0} + 1 ) ( {u}_{1}^{0} {u}_{2}^{0} + {u}_{1}^{T} {u}_{2} + 1 )} ++ {u}_{1} {u}_{2}^{T} \frac{2 {u}_{1}^{T} {u}_{2} + ( {u}_{1}^{0} + 1 ) ( {u}_{2}^{0} + 1 )}{( {u}_{1}^{0} + 1 ) ( {u}_{2}^{0} + 1 ) ( {u}_{1}^{0} {u}_{2}^{0} + {u}_{1}^{T} {u}_{2} + 1 )} + - {u}_{2} {u}_{1}^{T} \frac{1}{{u}_{1}^{0} {u}_{2}^{0} + {u}_{1}^{T} {u}_{2} + 1} = equ . ( 27 )$$

Annex 4

In this annex the scalar factor associated with each dyad u₁u₁^{T}, u₂u₂^{T}, u₁u₂^{T}, u₂u₁^{T} in equ.(41) is simplified to get equ.(27):

$${u}_{1} {u}_{1}^{T} : \{ - \frac{{( {u}_{2}^{0} + {u}_{3}^{0} )}^{2}}{{( {u}_{1}^{0} + 1 )}^{2} {u}_{3}^{0} ( {u}_{3}^{0} + 1 )} + \frac{1}{{u}_{1}^{0} + 1} - \frac{( {u}_{2}^{0} + {u}_{3}^{0} ) ( {u}_{3}^{0} {u}_{1}^{0} - {u}_{2}^{0} )}{{( {u}_{1}^{0} + 1 )}^{2} {u}_{3}^{0} ( {u}_{3}^{0} + 1 )} \} ⩵$$

$$\frac{\begin{matrix}- {( {u}_{2}^{0} + {u}_{3}^{0} )}^{2} + ( {u}_{1}^{0} + 1 ) {u}_{3}^{0} ( {u}_{3}^{0} + 1 ) - \\ ( {u}_{2}^{0} + {u}_{3}^{0} ) ( {u}_{3}^{0} {u}_{1}^{0} - {u}_{2}^{0} )\end{matrix}}{{( {u}_{1}^{0} + 1 )}^{2} {u}_{3}^{0} ( {u}_{3}^{0} + 1 )} ⩵ \frac{\begin{matrix}( {u}_{1}^{0} + 1 ) {u}_{3}^{0} ( {u}_{3}^{0} + 1 ) - \\ ( {u}_{2}^{0} + {u}_{3}^{0} ) ( {u}_{3}^{0} {u}_{1}^{0} + {u}_{3}^{0} )\end{matrix}}{{( {u}_{1}^{0} + 1 )}^{2} {u}_{3}^{0} ( {u}_{3}^{0} + 1 )} ⩵$$

$$\frac{( {u}_{1}^{0} + 1 ) ( {u}_{3}^{0} + 1 ) - ( {u}_{2}^{0} + {u}_{3}^{0} ) ( {u}_{1}^{0} + 1 )}{{( {u}_{1}^{0} + 1 )}^{2} ( {u}_{3}^{0} + 1 )} = \frac{( {u}_{3}^{0} + 1 ) - ( {u}_{2}^{0} + {u}_{3}^{0} )}{( {u}_{1}^{0} + 1 ) ( {u}_{3}^{0} + 1 )} ⩵$$

$$\frac{1 - {u}_{2}^{0}}{( {u}_{1}^{0} + 1 ) ( {u}_{3}^{0} + 1 )} = {=}^{{↓}^{{u}_{3}^{0} = {u}_{1}^{0} {u}_{2}^{0} + {u}_{1}^{T} {u}_{2} ( equ . ( 15 ) )}} \frac{1 - {u}_{2}^{0}}{( {u}_{1}^{0} + 1 ) ( {u}_{1}^{0} {u}_{2}^{0} + {u}_{1}^{T} {u}_{2} + 1 )}$$

$${u}_{2} {u}_{2}^{T} : \{ - \frac{1}{{u}_{3}^{0} ( {u}_{3}^{0} + 1 )} + \frac{1}{{u}_{2}^{0} + 1} - \frac{{u}_{3}^{0} ( {u}_{2}^{0} + {u}_{3}^{0} - {u}_{1}^{0} {u}_{2}^{0} ) + {( {u}_{2}^{0} )}^{2} - {u}_{1}^{0} - 1}{( {u}_{2}^{0} + 1 ) ( {u}_{1}^{0} + 1 ) {u}_{3}^{0} ( {u}_{3}^{0} + 1 )} + -$$

$$\frac{( {u}_{3}^{0} {u}_{1}^{0} - {u}_{2}^{0} )}{{u}_{3}^{0} ( {u}_{3}^{0} + 1 )} \frac{( {u}_{3}^{0} + {u}_{1}^{0} + {u}_{2}^{0} + 1 )}{( {u}_{1}^{0} + 1 ) ( {u}_{2}^{0} + 1 )} \} ⩵$$

$$\frac{\begin{matrix}- ( {u}_{2}^{0} + 1 ) ( {u}_{1}^{0} + 1 ) + ( {u}_{1}^{0} + 1 ) {u}_{3}^{0} ( {u}_{3}^{0} + 1 ) - \\ {u}_{3}^{0} ( {u}_{2}^{0} + {u}_{3}^{0} - {u}_{1}^{0} {u}_{2}^{0} ) - {( {u}_{2}^{0} )}^{2} + {u}_{1}^{0} + 1\end{matrix}}{( {u}_{2}^{0} + 1 ) ( {u}_{1}^{0} + 1 ) {u}_{3}^{0} ( {u}_{3}^{0} + 1 )} + -$$

$$\frac{( {u}_{3}^{0} {u}_{1}^{0} - {u}_{2}^{0} )}{{u}_{3}^{0} ( {u}_{3}^{0} + 1 )} \frac{( {u}_{3}^{0} + {u}_{1}^{0} + {u}_{2}^{0} + 1 )}{( {u}_{1}^{0} + 1 ) ( {u}_{2}^{0} + 1 )} ⩵$$

$$\frac{\begin{matrix}( {u}_{1}^{0} + 1 ) [ {u}_{3}^{0} ( {u}_{3}^{0} + 1 ) - ( {u}_{2}^{0} + 1 ) + 1 ] - \\ {u}_{3}^{0} ( {u}_{2}^{0} + {u}_{3}^{0} - {u}_{1}^{0} {u}_{2}^{0} ) - {( {u}_{2}^{0} )}^{2}\end{matrix}}{( {u}_{2}^{0} + 1 ) ( {u}_{1}^{0} + 1 ) {u}_{3}^{0} ( {u}_{3}^{0} + 1 )} + - \frac{( {u}_{3}^{0} {u}_{1}^{0} - {u}_{2}^{0} )}{{u}_{3}^{0} ( {u}_{3}^{0} + 1 )} \frac{( {u}_{3}^{0} + {u}_{1}^{0} + {u}_{2}^{0} + 1 )}{( {u}_{1}^{0} + 1 ) ( {u}_{2}^{0} + 1 )} ⩵$$

$$\frac{\begin{matrix}( {u}_{1}^{0} + 1 ) [ {u}_{3}^{0} ( {u}_{3}^{0} + 1 ) - {u}_{2}^{0} ] - \\ {u}_{3}^{0} ( {u}_{2}^{0} + {u}_{3}^{0} - {u}_{1}^{0} {u}_{2}^{0} ) - {( {u}_{2}^{0} )}^{2}\end{matrix}}{( {u}_{2}^{0} + 1 ) ( {u}_{1}^{0} + 1 ) {u}_{3}^{0} ( {u}_{3}^{0} + 1 )} + - \frac{( {u}_{3}^{0} {u}_{1}^{0} - {u}_{2}^{0} )}{{u}_{3}^{0} ( {u}_{3}^{0} + 1 )} \frac{( {u}_{3}^{0} + {u}_{1}^{0} + {u}_{2}^{0} + 1 )}{( {u}_{1}^{0} + 1 ) ( {u}_{2}^{0} + 1 )} ⩵$$

$$\frac{\begin{matrix}{u}_{1}^{0} [ {u}_{3}^{0} ( {u}_{3}^{0} + 1 ) - {u}_{2}^{0} ] + {u}_{3}^{0} ( {u}_{3}^{0} + 1 ) - \\ {u}_{2}^{0} - {u}_{3}^{0} ( {u}_{2}^{0} + {u}_{3}^{0} - {u}_{1}^{0} {u}_{2}^{0} ) - {( {u}_{2}^{0} )}^{2}\end{matrix}}{( {u}_{2}^{0} + 1 ) ( {u}_{1}^{0} + 1 ) {u}_{3}^{0} ( {u}_{3}^{0} + 1 )} + - \frac{( {u}_{3}^{0} {u}_{1}^{0} - {u}_{2}^{0} )}{{u}_{3}^{0} ( {u}_{3}^{0} + 1 )} \frac{( {u}_{3}^{0} + {u}_{1}^{0} + {u}_{2}^{0} + 1 )}{( {u}_{1}^{0} + 1 ) ( {u}_{2}^{0} + 1 )} ⩵$$

$$\frac{\begin{matrix}{u}_{1}^{0} {u}_{3}^{0} ( {u}_{3}^{0} + 1 ) - {u}_{1}^{0} {u}_{2}^{0} + {u}_{3}^{0} - \\ {u}_{2}^{0} - {u}_{3}^{0} ( {u}_{2}^{0} - {u}_{1}^{0} {u}_{2}^{0} ) - {( {u}_{2}^{0} )}^{2}\end{matrix}}{( {u}_{2}^{0} + 1 ) ( {u}_{1}^{0} + 1 ) {u}_{3}^{0} ( {u}_{3}^{0} + 1 )} + - \frac{( {u}_{3}^{0} {u}_{1}^{0} - {u}_{2}^{0} )}{{u}_{3}^{0} ( {u}_{3}^{0} + 1 )} \frac{( {u}_{3}^{0} + {u}_{1}^{0} + {u}_{2}^{0} + 1 )}{( {u}_{1}^{0} + 1 ) ( {u}_{2}^{0} + 1 )} ⩵$$

$$\frac{\begin{matrix}{u}_{1}^{0} {u}_{3}^{0} ( {u}_{3}^{0} + 1 ) - {u}_{1}^{0} {u}_{2}^{0} + {u}_{3}^{0} - \\ {u}_{2}^{0} - {u}_{2}^{0} {u}_{3}^{0} + {u}_{1}^{0} {u}_{2}^{0} {u}_{3}^{0} - {( {u}_{2}^{0} )}^{2}\end{matrix}}{( {u}_{2}^{0} + 1 ) ( {u}_{1}^{0} + 1 ) {u}_{3}^{0} ( {u}_{3}^{0} + 1 )} + - \frac{( {u}_{3}^{0} {u}_{1}^{0} - {u}_{2}^{0} )}{{u}_{3}^{0} ( {u}_{3}^{0} + 1 )} \frac{( {u}_{3}^{0} + {u}_{1}^{0} + {u}_{2}^{0} + 1 )}{( {u}_{1}^{0} + 1 ) ( {u}_{2}^{0} + 1 )} ⩵$$

$$\frac{{u}_{1}^{0} {u}_{3}^{0} ( {u}_{3}^{0} + 1 ) + {u}_{3}^{0} + {u}_{1}^{0} {u}_{2}^{0} {u}_{3}^{0}}{( {u}_{2}^{0} + 1 ) ( {u}_{1}^{0} + 1 ) {u}_{3}^{0} ( {u}_{3}^{0} + 1 )} - \frac{{u}_{3}^{0} {u}_{1}^{0}}{{u}_{3}^{0} ( {u}_{3}^{0} + 1 )} \frac{( {u}_{3}^{0} + {u}_{1}^{0} + {u}_{2}^{0} + 1 )}{{u}_{1}^{0} + 1 ) ( {u}_{2}^{0} + 1 )} ⩵$$

$$\frac{{u}_{3}^{0} [ 1 - {( {u}_{1}^{0} )}^{2} ]}{( {u}_{2}^{0} + 1 ) ( {u}_{1}^{0} + 1 ) {u}_{3}^{0} ( {u}_{3}^{0} + 1 )} =$$

$$\frac{1 - {u}_{1}^{0}}{( {u}_{2}^{0} + 1 ) ( {u}_{3}^{0} + 1 )} = {=}^{{↓}^{{u}_{3}^{0} = {u}_{1}^{0} {u}_{2}^{0} + {u}_{1}^{T} {u}_{2} ( equ . ( 15 ) )}} \frac{1 - {u}_{1}^{0}}{( {u}_{2}^{0} + 1 ) ( {u}_{1}^{0} {u}_{2}^{0} + {u}_{1}^{T} {u}_{2} + 1 )}$$

$${u}_{1} {u}_{2}^{T} : \{ - \frac{{u}_{2}^{0} + {u}_{3}^{0}}{{u}_{3}^{0} ( {u}_{3}^{0} + 1 ) ( {u}_{1}^{0} + 1 )} -$$

$$\frac{( {u}_{2}^{0} + {u}_{3}^{0} ) \cdot [ {u}_{3}^{0} ( {u}_{2}^{0} + {u}_{3}^{0} - {u}_{1}^{0} {u}_{2}^{0} ) + {( {u}_{2}^{0} )}^{2} - {u}_{1}^{0} - 1 ]}{{( {u}_{1}^{0} + 1 )}^{2} {u}_{3}^{0} ( {u}_{3}^{0} + 1 ) ( {u}_{2}^{0} + 1 )} ++$$

$$\frac{{u}_{3}^{0} + {u}_{1}^{0} + {u}_{2}^{0} + 1}{( {u}_{1}^{0} + 1 ) ( {u}_{2}^{0} + 1 )} [ 1 - \frac{( {u}_{2}^{0} + {u}_{3}^{0} ) \cdot ( {u}_{3}^{0} {u}_{1}^{0} - {u}_{2}^{0} )}{( {u}_{1}^{0} + 1 ) {u}_{3}^{0} ( {u}_{3}^{0} + 1 )} ] \} ⩵$$

$$- \frac{{u}_{2}^{0} + {u}_{3}^{0}}{{u}_{3}^{0} ( {u}_{3}^{0} + 1 ) ( {u}_{1}^{0} + 1 )} - \frac{( {u}_{2}^{0} + {u}_{3}^{0} ) \cdot [ {u}_{3}^{0} ( {u}_{2}^{0} + {u}_{3}^{0} - {u}_{1}^{0} {u}_{2}^{0} ) + {( {u}_{2}^{0} )}^{2} - {u}_{1}^{0} - 1 ]}{{( {u}_{1}^{0} + 1 )}^{2} {u}_{3}^{0} ( {u}_{3}^{0} + 1 ) ( {u}_{2}^{0} + 1 )} ++$$

$$\frac{{u}_{3}^{0} + {u}_{1}^{0} + {u}_{2}^{0} + 1}{( {u}_{1}^{0} + 1 ) ( {u}_{2}^{0} + 1 )} \cdot \frac{( {u}_{1}^{0} + 1 ) {u}_{3}^{0} ( {u}_{3}^{0} + 1 ) - ( {u}_{2}^{0} + {u}_{3}^{0} ) \cdot ( {u}_{3}^{0} {u}_{1}^{0} - {u}_{2}^{0} )}{( {u}_{1}^{0} + 1 ) {u}_{3}^{0} ( {u}_{3}^{0} + 1 )} ⩵$$

$$- \frac{{u}_{2}^{0} + {u}_{3}^{0}}{{u}_{3}^{0} ( {u}_{3}^{0} + 1 ) ( {u}_{1}^{0} + 1 )} - \frac{( {u}_{2}^{0} + {u}_{3}^{0} ) \cdot [ {u}_{3}^{0} ( {u}_{2}^{0} + {u}_{3}^{0} - {u}_{1}^{0} {u}_{2}^{0} ) + {( {u}_{2}^{0} )}^{2} - {u}_{1}^{0} - 1 ]}{{( {u}_{1}^{0} + 1 )}^{2} {u}_{3}^{0} ( {u}_{3}^{0} + 1 ) ( {u}_{2}^{0} + 1 )} ++$$

$$\frac{{u}_{3}^{0} + {u}_{1}^{0} + {u}_{2}^{0} + 1}{( {u}_{1}^{0} + 1 ) ( {u}_{2}^{0} + 1 )} \cdot \frac{\begin{matrix}{u}_{1}^{0} {u}_{3}^{0} ( {u}_{3}^{0} + 1 ) + {u}_{3}^{0} ( {u}_{3}^{0} + 1 ) - {u}_{2}^{0} ( {u}_{3}^{0} {u}_{1}^{0} - {u}_{2}^{0} ) - \\ {u}_{3}^{0} ( {u}_{3}^{0} {u}_{1}^{0} - {u}_{2}^{0} )\end{matrix}}{( {u}_{1}^{0} + 1 ) {u}_{3}^{0} ( {u}_{3}^{0} + 1 )} ⩵$$

$$- \frac{{u}_{2}^{0} + {u}_{3}^{0}}{{u}_{3}^{0} ( {u}_{3}^{0} + 1 ) ( {u}_{1}^{0} + 1 )} - \frac{( {u}_{2}^{0} + {u}_{3}^{0} ) \cdot [ {u}_{3}^{0} ( {u}_{2}^{0} + {u}_{3}^{0} - {u}_{1}^{0} {u}_{2}^{0} ) + {( {u}_{2}^{0} )}^{2} - {u}_{1}^{0} - 1 ]}{{( {u}_{1}^{0} + 1 )}^{2} {u}_{3}^{0} ( {u}_{3}^{0} + 1 ) ( {u}_{2}^{0} + 1 )} ++$$

$$\frac{{u}_{3}^{0} + {u}_{1}^{0} + {u}_{2}^{0} + 1}{( {u}_{1}^{0} + 1 ) ( {u}_{2}^{0} + 1 )} \cdot \frac{( {u}_{1}^{0} + 1 ) {u}_{3}^{0} + {u}_{3}^{0} ( {u}_{3}^{0} + {u}_{2}^{0} - {u}_{1}^{0} {u}_{2}^{0} ) + {( {u}_{2}^{0} )}^{2}}{( {u}_{1}^{0} + 1 ) {u}_{3}^{0} ( {u}_{3}^{0} + 1 )} ⩵$$

$$- \frac{{u}_{2}^{0} + {u}_{3}^{0}}{{u}_{3}^{0} ( {u}_{3}^{0} + 1 ) ( {u}_{1}^{0} + 1 )} - \frac{( {u}_{2}^{0} + {u}_{3}^{0} ) \cdot [ {u}_{3}^{0} ( {u}_{2}^{0} + {u}_{3}^{0} - {u}_{1}^{0} {u}_{2}^{0} ) + {( {u}_{2}^{0} )}^{2} - {u}_{1}^{0} - 1 ]}{{( {u}_{1}^{0} + 1 )}^{2} {u}_{3}^{0} ( {u}_{3}^{0} + 1 ) ( {u}_{2}^{0} + 1 )} ++$$

$$\frac{{u}_{3}^{0} + {u}_{2}^{0}}{( {u}_{1}^{0} + 1 ) ( {u}_{2}^{0} + 1 )} \cdot \frac{( {u}_{1}^{0} + 1 ) {u}_{3}^{0} + {u}_{3}^{0} ( {u}_{3}^{0} + {u}_{2}^{0} - {u}_{1}^{0} {u}_{2}^{0} ) + {( {u}_{2}^{0} )}^{2}}{( {u}_{1}^{0} + 1 ) {u}_{3}^{0} ( {u}_{3}^{0} + 1 )} ++$$

$$\frac{{u}_{1}^{0} + 1}{( {u}_{1}^{0} + 1 ) ( {u}_{2}^{0} + 1 )} \cdot \frac{( {u}_{1}^{0} + 1 ) {u}_{3}^{0} + {u}_{3}^{0} ( {u}_{3}^{0} + {u}_{2}^{0} - {u}_{1}^{0} {u}_{2}^{0} ) + {( {u}_{2}^{0} )}^{2}}{( {u}_{1}^{0} + 1 ) {u}_{3}^{0} ( {u}_{3}^{0} + 1 )} ⩵$$

$$- \frac{{u}_{2}^{0} + {u}_{3}^{0}}{{u}_{3}^{0} ( {u}_{3}^{0} + 1 ) ( {u}_{1}^{0} + 1 )} + \frac{( {u}_{2}^{0} + {u}_{3}^{0} ) \cdot ( {u}_{1}^{0} + 1 )}{{( {u}_{1}^{0} + 1 )}^{2} {u}_{3}^{0} ( {u}_{3}^{0} + 1 ) ( {u}_{2}^{0} + 1 )} ++ \frac{{u}_{3}^{0} + {u}_{2}^{0}}{( {u}_{1}^{0} + 1 ) ( {u}_{2}^{0} + 1 )} \cdot$$

$$\frac{( {u}_{1}^{0} + 1 ) {u}_{3}^{0}}{( {u}_{1}^{0} + 1 ) {u}_{3}^{0} ( {u}_{3}^{0} + 1 )} ++ \frac{{u}_{1}^{0} + 1}{( {u}_{1}^{0} + 1 ) ( {u}_{2}^{0} + 1 )} \cdot$$

$$\frac{( {u}_{1}^{0} + 1 ) {u}_{3}^{0} + {u}_{3}^{0} ( {u}_{3}^{0} + {u}_{2}^{0} - {u}_{1}^{0} {u}_{2}^{0} ) + {( {u}_{2}^{0} )}^{2}}{( {u}_{1}^{0} + 1 ) {u}_{3}^{0} ( {u}_{3}^{0} + 1 )} ⩵ - \frac{( {u}_{2}^{0} + {u}_{3}^{0} ) ( {u}_{2}^{0} + 1 )}{{u}_{3}^{0} ( {u}_{3}^{0} + 1 ) ( {u}_{1}^{0} + 1 ) ( {u}_{2}^{0} + 1 )} +$$

$$\frac{{u}_{2}^{0} + {u}_{3}^{0}}{( {u}_{1}^{0} + 1 ) {u}_{3}^{0} ( {u}_{3}^{0} + 1 ) ( {u}_{2}^{0} + 1 )} ++ \frac{( {u}_{3}^{0} + {u}_{2}^{0} ) {u}_{3}^{0}}{( {u}_{1}^{0} + 1 ) {u}_{3}^{0} ( {u}_{3}^{0} + 1 ) ( {u}_{2}^{0} + 1 )} ++$$

$$\frac{( {u}_{1}^{0} + 1 ) {u}_{3}^{0} + {u}_{3}^{0} ( {u}_{3}^{0} + {u}_{2}^{0} - {u}_{1}^{0} {u}_{2}^{0} ) + {( {u}_{2}^{0} )}^{2}}{( {u}_{1}^{0} + 1 ) {u}_{3}^{0} ( {u}_{3}^{0} + 1 ) ( {u}_{2}^{0} + 1 )} ⩵$$

$$\frac{{( {u}_{3}^{0} )}^{2} + ( {u}_{1}^{0} + 1 ) {u}_{3}^{0} + {u}_{3}^{0} ( {u}_{3}^{0} + {u}_{2}^{0} - {u}_{1}^{0} {u}_{2}^{0} )}{( {u}_{1}^{0} + 1 ) {u}_{3}^{0} ( {u}_{3}^{0} + 1 ) ( {u}_{2}^{0} + 1 )} ⩵$$

$$\frac{2 {u}_{3}^{0} + {u}_{1}^{0} + {u}_{2}^{0} - {u}_{1}^{0} {u}_{2}^{0} + 1}{( {u}_{1}^{0} + 1 ) ( {u}_{3}^{0} + 1 ) ( {u}_{2}^{0} + 1 )} = {=}^{{↓}^{{u}_{3}^{0} = {u}_{1}^{0} {u}_{2}^{0} + {u}_{1}^{T} {u}_{2} ( equ . ( 15 ) )}}$$

$$\frac{2 ( {u}_{1}^{0} {u}_{2}^{0} + {u}_{1}^{T} {u}_{2} ) + {u}_{1}^{0} + {u}_{2}^{0} - {u}_{1}^{0} {u}_{2}^{0} + 1}{( {u}_{1}^{0} + 1 ) ( {u}_{1}^{0} {u}_{2}^{0} + {u}_{1}^{T} {u}_{2} + 1 ) ( {u}_{2}^{0} + 1 )} ⩵$$

$$\frac{2 {u}_{1}^{T} {u}_{2} + {u}_{1}^{0} + {u}_{2}^{0} + {u}_{1}^{0} {u}_{2}^{0} + 1}{( {u}_{1}^{0} + 1 ) ( {u}_{1}^{0} {u}_{2}^{0} + {u}_{1}^{T} {u}_{2} + 1 ) ( {u}_{2}^{0} + 1 )} ⩵ \frac{2 {u}_{1}^{T} {u}_{2} + ( {u}_{1}^{0} + 1 ) ( {u}_{2}^{0} + 1 )}{( {u}_{1}^{0} + 1 ) ( {u}_{2}^{0} + 1 ) ( {u}_{1}^{0} {u}_{2}^{0} + {u}_{1}^{T} {u}_{2} + 1 )}$$

$${u}_{2} {u}_{1}^{T} : \{ - \frac{{u}_{2}^{0} + {u}_{3}^{0}}{{( {u}_{1}^{0} + )}^{2}} \frac{{u}_{1}^{0} + 1}{{u}_{3}^{0} ( {u}_{3}^{0} + 1 )} - \frac{( {u}_{1}^{0} + 1 ) ( {u}_{3}^{0} {u}_{1}^{0} - {u}_{2}^{0} )}{{( {u}_{1}^{0} + 1 )}^{2} {u}_{3}^{0} ( {u}_{3}^{0} + 1 )} \} ⩵$$

$$- \frac{{u}_{2}^{0} + {u}_{3}^{0}}{( {u}_{1}^{0} + 1 ) {u}_{3}^{0} ( {u}_{3}^{0} + 1 )} - \frac{{u}_{3}^{0} {u}_{1}^{0} - {u}_{2}^{0}}{( {u}_{1}^{0} + 1 ) {u}_{3}^{0} ( {u}_{3}^{0} + 1 )} ⩵ - \frac{{u}_{3}^{0} ( {u}_{1}^{0} + 1 )}{( {u}_{1}^{0} + 1 ) {u}_{3}^{0} ( {u}_{3}^{0} + 1 )} =$$

$$- \frac{1}{{u}_{3}^{0} + 1} = {=}^{{↓}^{{u}_{3}^{0} = {u}_{1}^{0} {u}_{2}^{0} + {u}_{1}^{T} {u}_{2} ( equ . ( 15 ) )}} - \frac{1}{{u}_{1}^{0} {u}_{2}^{0} + {u}_{1}^{T} {u}_{2} + 1}$$

Annex 5

In this annex equ. (27) is separated into the symmetric and the antisymmetric (skewsymmetric) part to get the Rodrigues form of equ.(28):

$$equ . ( 27 ) = 1 + {u}_{1} {u}_{1}^{T} \frac{1 - {u}_{2}^{0}}{( {u}_{1}^{0} + 1 ) ( {u}_{1}^{0} {u}_{2}^{0} + {u}_{1}^{T} {u}_{2} + 1 )} ++$$

$${u}_{2} {u}_{2}^{T} \frac{1 - {u}_{1}^{0}}{( {u}_{2}^{0} + 1 ) ( {u}_{1}^{0} {u}_{2}^{0} + {u}_{1}^{T} {u}_{2} + 1 )} ++ {u}_{1} {u}_{2}^{T} \frac{2 {u}_{1}^{T} {u}_{2} + ( {u}_{1}^{0} + 1 ) ( {u}_{2}^{0} + 1 )}{( {u}_{1}^{0} + 1 ) ( {u}_{2}^{0} + 1 ) ( {u}_{1}^{0} {u}_{2}^{0} + {u}_{1}^{T} {u}_{2} + 1 )} +$$

$$- {u}_{2} {u}_{1}^{T} \frac{1}{{u}_{1}^{0} {u}_{2}^{0} + {u}_{1}^{T} {u}_{2} + 1} == 1 + \frac{1}{{u}_{1}^{0} {u}_{2}^{0} + {u}_{1}^{T} {u}_{2} + 1} \cdot \cdot$$

$$[ {u}_{1} {u}_{1}^{T} \frac{1 - {u}_{2}^{0}}{{u}_{1}^{0} + 1} + {u}_{2} {u}_{2}^{T} \frac{1 - {u}_{1}^{0}}{{u}_{2}^{0} + 1} + {u}_{1} {u}_{2}^{T} ( \frac{2 {u}_{1}^{T} {u}_{2}}{( {u}_{1}^{0} + 1 ) ( {u}_{2}^{0} + 1 )} + 1 ) - {u}_{2} {u}_{1}^{T} ] =$$

$$R = \frac{1}{2} ( R + {R}^{T} ) + \frac{1}{2} ( R - {R}^{T} ) {=}^{↓} 1 + \frac{1}{{u}_{1}^{0} {u}_{2}^{0} + {u}_{1}^{T} {u}_{2} + 1} \cdot \cdot$$

$$[ {u}_{1} {u}_{1}^{T} \frac{1 - {u}_{2}^{0}}{{u}_{1}^{0} + 1} + {u}_{2} {u}_{2}^{T} \frac{1 - {u}_{1}^{0}}{{u}_{2}^{0} + 1} ++ \frac{1}{2} ( {u}_{1} {u}_{2}^{T} + {u}_{2} {u}_{1}^{T} ) ( \frac{2 {u}_{1}^{T} {u}_{2}}{( {u}_{1}^{0} + 1 ) ( {u}_{2}^{0} + 1 )} + 1 ) -$$

$$\frac{1}{2} ( {u}_{2} {u}_{1}^{T} + {u}_{1} {u}_{2}^{T} ) ++ \frac{1}{2} ( {u}_{1} {u}_{2}^{T} - {u}_{2} {u}_{1}^{T} ) ( \frac{2 {u}_{1}^{T} {u}_{2}}{( {u}_{1}^{0} + 1 ) ( {u}_{2}^{0} + 1 )} + 1 ) -$$

$$\frac{1}{2} ( {u}_{2} {u}_{1}^{T} - {u}_{1} {u}_{2}^{T} ) ] == 1 + \frac{1}{{u}_{1}^{0} {u}_{2}^{0} + {u}_{1}^{T} {u}_{2} + 1} [ {u}_{1} {u}_{1}^{T} \frac{1 - {u}_{2}^{0}}{{u}_{1}^{0} + 1} + {u}_{2} {u}_{2}^{T} \frac{1 - {u}_{1}^{0}}{{u}_{2}^{0} + 1} ++$$

$$\frac{1}{2} ( {u}_{1} {u}_{2}^{T} + {u}_{2} {u}_{1}^{T} ) \frac{2 {u}_{1}^{T} {u}_{2}}{( {u}_{1}^{0} + 1 ) ( {u}_{2}^{0} + 1 )} ++$$

$$\frac{1}{2} ( {u}_{1} {u}_{2}^{T} - {u}_{2} {u}_{1}^{T} ) ( \frac{2 {u}_{1}^{T} {u}_{2}}{( {u}_{1}^{0} + 1 ) ( {u}_{2}^{0} + 1 )} + 2 ) ] ==$$

$$1 + \frac{1}{{u}_{1}^{0} {u}_{2}^{0} + {u}_{1}^{T} {u}_{2} + 1} [ {u}_{1} {u}_{1}^{T} \frac{1 - {u}_{2}^{0}}{{u}_{1}^{0} + 1} + {u}_{2} {u}_{2}^{T} \frac{1 - {u}_{1}^{0}}{{u}_{2}^{0} + 1} ++$$

$$( {u}_{1} {u}_{2}^{T} + {u}_{2} {u}_{1}^{T} ) \frac{{u}_{1}^{T} {u}_{2}}{( {u}_{1}^{0} + 1 ) ( {u}_{2}^{0} + 1 )} + ( {u}_{1} {u}_{2}^{T} - {u}_{2} {u}_{1}^{T} ) ( \frac{{u}_{1}^{T} {u}_{2}}{( {u}_{1}^{0} + 1 ) ( {u}_{2}^{0} + 1 )} + 1 ) ] ==$$

$$1 + \frac{1}{( {u}_{1}^{0} {u}_{2}^{0} + {u}_{1}^{T} {u}_{2} + 1 ) ( {u}_{1}^{0} + 1 ) ( {u}_{2}^{0} + 1 )} \cdot [ {u}_{1} {u}_{1}^{T} ( 1 - {u}_{2}^{0} ) ( {u}_{2}^{0} + 1 ) +$$

$${u}_{2} {u}_{2}^{T} ( 1 - {u}_{1}^{0} ) ( {u}_{1}^{0} + 1 ) ++ ( {u}_{1} {u}_{2}^{T} + {u}_{2} {u}_{1}^{T} ) {u}_{1}^{T} {u}_{2} ++$$

$$( {u}_{1} {u}_{2}^{T} - {u}_{2} {u}_{1}^{T} ) [ {u}_{1}^{T} {u}_{2} + ( {u}_{1}^{0} + 1 ) ( {u}_{2}^{0} + 1 ) ] ] == 1 +$$

$$\frac{1}{( {u}_{1}^{0} {u}_{2}^{0} + {u}_{1}^{T} {u}_{2} + 1 ) ( {u}_{1}^{0} + 1 ) ( {u}_{2}^{0} + 1 )} \cdot [ {u}_{1} {u}_{1}^{T} [ 1 - {( {u}_{2}^{0} )}^{2} ] + {u}_{2} {u}_{2}^{T} [ 1 - {( {u}_{1}^{0} )}^{2} ] ++$$

$$( {u}_{1} {u}_{2}^{T} + {u}_{2} {u}_{1}^{T} ) {u}_{1}^{T} {u}_{2} ++ ( {u}_{1} {u}_{2}^{T} - {u}_{2} {u}_{1}^{T} ) [ {u}_{1}^{T} {u}_{2} + ( {u}_{1}^{0} + 1 ) ( {u}_{2}^{0} + 1 ) ] ] =$$

$$1 + \frac{1}{( {u}_{1}^{0} {u}_{2}^{0} + {u}_{1}^{T} {u}_{2} + 1 ) ( {u}_{1}^{0} + 1 ) ( {u}_{2}^{0} + 1 )} \cdot [ - {( {u}_{2} )}^{2} {u}_{1} {u}_{1}^{T} - {( {u}_{1} )}^{2} {u}_{2} {u}_{2}^{T} +$$

$$( {u}_{1} {u}_{2}^{T} + {u}_{2} {u}_{1}^{T} ) {u}_{1}^{T} {u}_{2} + - ( {u}_{2} {u}_{1}^{T} - {u}_{1} {u}_{2}^{T} ) [ {u}_{1}^{T} {u}_{2} + ( {u}_{1}^{0} + 1 ) ( {u}_{2}^{0} + 1 ) ] ] = …$$

For the further transformation we need the following identities:

$${[ {u}_{1} \times {u}_{2} ]}_{\times } {=}^{{↓}^{[ 6 , fact 4.12 \text{.1} xi ) on p \text{.384} ]}} {u}_{2} {u}_{1}^{T} - {u}_{1} {u}_{2}^{T} ⇒ {[ {u}_{1} \times {u}_{2} ]}_{\times }^{2} == ( {u}_{2} {u}_{1}^{T} - {u}_{1} {u}_{2}^{T} ) ( {u}_{2} {u}_{1}^{T} - {u}_{1} {u}_{2}^{T} ) == {u}_{2} {u}_{1}^{T} {u}_{2} {u}_{1}^{T} - {u}_{2} {u}_{1}^{T} {u}_{1} {u}_{2}^{T} - {u}_{1} {u}_{2}^{T} {u}_{2} {u}_{1}^{T} + {u}_{1} {u}_{2}^{T} {u}_{1} {u}_{2}^{T} == ( {u}_{1}^{T} {u}_{2} ) {u}_{2} {u}_{1}^{T} - ( {u}_{1}^{2} ) {u}_{2} {u}_{2}^{T} - ( {u}_{2}^{2} ) {u}_{1} {u}_{1}^{T} + ( {u}_{2}^{T} {u}_{1} ) {u}_{1} {u}_{2}^{T} == - ( {u}_{1}^{2} ) {u}_{2} {u}_{2}^{T} + ( {u}_{1}^{T} {u}_{2} ) ( {u}_{2} {u}_{1}^{T} + {u}_{1} {u}_{2}^{T} ) - ( {u}_{2}^{2} ) {u}_{1} {u}_{1}^{T}$$

Now we can resume the transformation:

$$… = 1 + \frac{1}{( {u}_{1}^{0} {u}_{2}^{0} + {u}_{1}^{T} {u}_{2} + 1 ) ( {u}_{1}^{0} + 1 ) ( {u}_{2}^{0} + 1 )} \cdot$$

$$[ {[ {u}_{1} \times {u}_{2} ]}_{\times }^{2} - {[ {u}_{1} \times {u}_{2} ]}_{\times } [ {u}_{1}^{T} {u}_{2} + ( {u}_{1}^{0} + 1 ) ( {u}_{2}^{0} + ) ] ] ==$$

$${\underbrace{1 + {\frac{1}{( {u}_{1}^{0} {u}_{2}^{0} + {u}_{1}^{T} {u}_{2} + 1 ) ( {u}_{1}^{0} + 1 ) ( {u}_{2}^{0} + 1 )} [ {u}_{1} \times {u}_{2} ]}_{\times }^{2}}}_{\frac{1}{2} ( R + {R}^{T} )} +$$

$${\underbrace{- {\frac{{u}_{1}^{T} {u}_{2} + ( {u}_{1}^{0} + 1 ) ( {u}_{2}^{0} + 1 )}{( {u}_{1}^{0} {u}_{2}^{0} + {u}_{1}^{T} {u}_{2} + 1 ) ( {u}_{1}^{0} + 1 ) ( {u}_{2}^{0} + 1 )} [ {u}_{1} \times {u}_{2} ]}_{\times }}}_{\frac{1}{2} ( R - {R}^{T} )} = {=}^{{↓}^{equ . ( 15 )}}$$

$$1 - {\frac{{u}_{1}^{0} + {u}_{2}^{0} + {\overbrace{{u}_{1}^{0} {u}_{2}^{0} + {u}_{1}^{T} {u}_{2}}}^{{u}_{3}^{0}} + 1}{( {u}_{1}^{0} + 1 ) ( {u}_{2}^{0} + 1 ) ( {\underbrace{{u}_{1}^{0} {u}_{2}^{0} + {u}_{1}^{T} {u}_{2}}}_{{u}_{3}^{0}} + 1 )} [ {u}_{1} \times {u}_{2} ]}_{\times } ++ {\frac{1}{( {u}_{1}^{0} + 1 ) ( {u}_{2}^{0} + 1 ) ( {\underbrace{{u}_{1}^{0} {u}_{2}^{0} + {u}_{1}^{T} {u}_{2}}}_{{u}_{3}^{0}} + 1 )} [ {u}_{1} \times {u}_{2} ]}_{\times }^{2} = equ . ( 28 )$$

Annex 6

In this annex we show that equ.(27) corresponds to the result obtained by Fahnline [1, equ.(30) on p. 820]:

We denoted above the components of the four dimensional matrix ^{W}Rη representing the mixed Wigner rotation tensor with R^{μ}_{ν} (μ, ν=0, 1, 2, 3), the components of the three dimensional submatrix ^{W}R are thus ^{W}Rⁱⱼ=^{W}Rⁱⱼ with i, j=1, 2, 3. Comparing [1, equ.(21) on p. 820] with equ.(16) above one can see that Fahnline denotes the components of the three dimensional transposed submatrix ^{W}R^{T} in equation [1, equ.(30) on p. 820] as Rⁱⱼ, said equation reads (there is a typing error at the end of the first line of said equation: υ_{B}ⁱb_{B}_{ⱼ} should read υ_{B}ⁱυ_{B}_{ⱼ}):

$${R}_{j}^{i} = {δ}_{j}^{i} + [ ( 1 - {γ}_{B}^{2} ) {v}_{A}^{i} {v}_{Aj} + ( 1 - {γ}_{A}^{2} ) {v}_{B}^{i} {v}_{Bj} + - ( 1 + {γ}_{A} ) ( 1 + {γ}_{B} ) {v}_{A}^{i} {v}_{Bj} ++ ( 1 + {γ}_{A} + {γ}_{B} + 3 {γ}_{A} {γ}_{B} - 2 ψ ) {v}_{B}^{i} {v}_{Aj} ] \cdot \cdot \frac{1}{{c}^{2} ( 1 + {γ}_{A} ) ( 1 + {γ}_{B} ) ( 1 + 2 {γ}_{A} {γ}_{B} - ψ )} \qquad ( 42 )$$

As already mentioned in the paragraph below equ.(3) above Fahnline [1] defines the four-velocity without the factor 1/c, therefore the following identities apply:

$$\frac{{v}_{A}^{i} {v}_{Aj}}{{c}^{2}}$$

are the components of the dyad we denote with u₁u₁^{T},

$$\frac{{v}_{B}^{i} {v}_{Bj}}{{c}^{2}}$$

are the components of the dyad we denote with u₂u₂^{T},

$$\frac{{v}_{A}^{i} {v}_{Bj}}{{c}^{2}}$$

are the components of the dyad we denote with u₁u₂^{T}, and

$$\frac{{v}_{B}^{i} {v}_{Aj}}{{c}^{2}}$$

are the components of the dyad we denote with u₂u₁^{T}.

According to equ.(2) above and [1, paragraph between equations (25) and (26) on p. 820] further the following identities apply:

γ_{A}=u₁⁰Λγ_{B}=u₂⁰Λψ=−u₁·u₂=u₁⁰u₂⁰−u₁^{T}u₂

Thus equ.(42) translated into our notation and using matrix notation instead of component notation reads

$${W}^{} {R}^{T} = 1 + \{ [ 1 - {( {u}_{2}^{0} )}^{2} ] {u}_{1} {u}_{1}^{T} + [ 1 - {( {u}_{1}^{0} )}^{2} ] {u}_{2} {u}_{2}^{T} + - ( 1 + {u}_{1}^{0} ) ( 1 + {u}_{2}^{0} ) {u}_{1} {u}_{2}^{T} ++ [ 1 + {u}_{1}^{0} + {u}_{2}^{0} + 3 {u}_{1}^{0} {u}_{2}^{0} - 2 ( {u}_{1}^{0} {u}_{2}^{0} - {u}_{1}^{T} {u}_{2} ) ] {u}_{2} {u}_{1}^{T} \} \cdot \cdot \frac{1}{( 1 + {u}_{1}^{0} ) ( 1 + {u}_{2}^{0} ) [ 1 + 2 {u}_{1}^{0} {u}_{2}^{0} - ( {u}_{1}^{0} {u}_{2}^{0} - {u}_{1}^{T} {u}_{2} ) ]} == 1 + \{ ( 1 - {u}_{2}^{0} ) ( 1 + {u}_{2}^{0} ) {u}_{1} {u}_{1}^{T} + ( 1 - {u}_{1}^{0} ) ( 1 + {u}_{1}^{0} ) {u}_{2} {u}_{2}^{T} + - ( 1 + {u}_{1}^{0} ) ( 1 + {u}_{2}^{0} ) {u}_{1} {u}_{2}^{T} ++ ( 1 + {u}_{1}^{0} + {u}_{2}^{0} + {u}_{1}^{0} {u}_{2}^{0} + 2 {u}_{1}^{T} {u}_{2} ) {u}_{2} {u}_{1}^{T} \} \cdot \cdot \frac{1}{( 1 + {u}_{1}^{0} ) ( 1 + {u}_{2}^{0} ) ( 1 + {u}_{1}^{0} {u}_{2}^{0} + {u}_{1}^{T} {u}_{2} )} == 1 + \frac{1 - {u}_{2}^{0}}{( 1 + {u}_{1}^{0} ) ( 1 + {u}_{1}^{0} {u}_{2}^{0} + {u}_{1}^{T} {u}_{2} )} {u}_{1} {u}_{1}^{T} + \frac{1 - {u}_{1}^{0}}{( 1 + {u}_{2}^{0} ) ( 1 + {u}_{1}^{0} {u}_{2}^{0} + {u}_{1}^{T} {u}_{2} )} {u}_{2} {u}_{2}^{T} + - \frac{1}{1 + {u}_{1}^{0} {u}_{2}^{0} + {u}_{1}^{T} {u}_{2}} {u}_{1} {u}_{2}^{T} ++ \frac{1 + {u}_{1}^{0} + {u}_{2}^{0} + {u}_{1}^{0} {u}_{2}^{0} + 2 {u}_{1}^{T} {u}_{2}}{( 1 + {u}_{1}^{0} ) ( 1 + {u}_{2}^{0} ) ( 1 + {u}_{1}^{0} {u}_{2}^{0} + {u}_{1}^{T} {u}_{2} )} {u}_{2} {u}_{1}^{T}$$

This is the transposed of equ.(27) above.

Annex 7

In this annex the equivalence of equ.(31) and (32) is proven:

$$equ . ( 31 ) = 1 - \frac{{( {u}_{1} \times {u}_{2} )}^{2}}{( {u}_{1}^{0} {u}_{2}^{0} + {u}_{1}^{T} {u}_{2} + 1 ) ( {u}_{1}^{0} + 1 ) ( {u}_{2}^{0} + 1 )} == 1 - \frac{{u}_{1}^{2} {u}_{2}^{2} - {( {u}_{1}^{T} {u}_{2} )}^{2}}{( {u}_{1}^{0} {u}_{2}^{0} + {u}_{1}^{T} {u}_{2} + 1 ) ( {u}_{1}^{0} + 1 ) ( {u}_{2}^{0} + 1 )} == 1 - \frac{{u}_{1}^{2} {u}_{2}^{2} - {( {u}_{1}^{0} {u}_{2}^{0} + {u}_{1}^{T} {u}_{2} - {u}_{1}^{0} {u}_{2}^{0} )}^{2}}{( {u}_{1}^{0} {u}_{2}^{0} + {u}_{1}^{T} {u}_{2} + 1 ) ( {u}_{1}^{0} + 1 ) ( {u}_{2}^{0} + 1 )} == 1 - \frac{{u}_{1}^{2} {u}_{2}^{2} - {( {u}_{3}^{0} - {u}_{1}^{0} {u}_{2}^{0} )}^{2}}{( {u}_{3}^{0} + 1 ) ( {u}_{1}^{0} + 1 ) ( {u}_{2}^{0} + 1 )} == 1 - \frac{1}{( {u}_{3}^{0} + 1 )} [ \frac{( {u}_{1}^{2} + 1 - 1 ) ( {u}_{2}^{2} + 1 - 1 )}{( {u}_{1}^{0} + 1 ) ( {u}_{2}^{0} + 1 )} - \frac{{( {u}_{3}^{0} - {u}_{1}^{0} {u}_{2}^{0} )}^{2}}{( {u}_{1}^{0} + 1 ) ( {u}_{2}^{0} + 1 )} ] == 1 - \frac{1}{( {u}_{3}^{0} + 1 )} [ \frac{( {( {u}_{1}^{0} )}^{2} - 1 ) ( {( {u}_{2}^{0} )}^{2} - 1 )}{( {u}_{1}^{0} + 1 ) ( {u}_{2}^{0} + 1 )} - \frac{{( {u}_{3}^{0} - {u}_{1}^{0} {u}_{2}^{0} )}^{2}}{( {u}_{1}^{0} + 1 ) ( {u}_{2}^{0} + 1 )} ] == 1 - \frac{1}{( {u}_{3}^{0} + 1 )} [ ( {u}_{1}^{0} - 1 ) ( {u}_{2}^{0} - 1 ) - \frac{{( {u}_{3}^{0} - {u}_{1}^{0} {u}_{2}^{0} )}^{2}}{( {u}_{1}^{0} + 1 ) ( {u}_{2}^{0} + 1 )} ] = {=}^{{↓}^{[ 4 , p \text{.213} , last two equations ]}} \frac{{( {u}_{1}^{0} + {u}_{2}^{0} + {\overbrace{{u}_{1}^{0} {u}_{2}^{0} + {u}_{1}^{T} {u}_{2}}}^{{u}_{3}^{0}} + 1 )}^{2}}{( {u}_{1}^{0} + 1 ) ( {u}_{2}^{0} + 1 ) ( {\underbrace{{u}_{1}^{0} {u}_{2}^{0} + {u}_{1}^{T} {u}_{2}}}_{{u}_{3}^{0}} + 1 )} - 1 = equ . ( 32 )$$

Annex 8

In this annex it is proven that equ.(28) constitutes a rotation matrix and that the expressions in equ.(30) and (31) constitute a sine and a cosine:

$${cos}^{2 W} + {sin}^{2 W} - 1 = {[ 1 - \frac{{( {u}_{1} \times {u}_{2} )}^{2}}{( {u}_{1}^{0} {u}_{2}^{0} + {u}_{1}^{T} {u}_{2} + 1 ) ( {u}_{1}^{0} + 1 ) ( {u}_{2}^{0} + 1 )} ]}^{2} ++$$

$${[ - \frac{( {u}_{1}^{0} + {u}_{2}^{0} + {u}_{1}^{0} {u}_{2}^{0} + {u}_{1}^{T} {u}_{2} + 1 ) \sqrt{{( {u}_{1} \times {u}_{2} )}^{2}}}{( {u}_{1}^{0} {u}_{2}^{0} + {u}_{1}^{T} {u}_{2} + 1 ) ( {u}_{1}^{0} + 1 ) ( {u}_{2}^{0} + 1 )} ]}^{2} - 1 ==$$

$${[ \frac{{( {u}_{1} \times {u}_{2} )}^{2}}{( {u}_{1}^{0} {u}_{2}^{0} + {u}_{1}^{T} {u}_{2} + 1 ) ( {u}_{1}^{0} + 1 ) ( {u}_{2}^{0} + 1 )} - 1 ]}^{2} -$$

$${{1}^{2} ++ [ \frac{( {u}_{1}^{0} + {u}_{2}^{0} + {u}_{1}^{0} {u}_{2}^{0} + {u}_{1}^{T} {u}_{2} + 1 ) \sqrt{{( {u}_{1} \times {u}_{2} )}^{2}}}{( {u}_{1}^{0} {u}_{2}^{0} + {u}_{1}^{T} {u}_{2} + 1 ) ( {u}_{1}^{0} + 1 ) ( {u}_{2}^{0} + 1 )} ]}^{2} ==$$

$$[ \frac{{( {u}_{1} \times {u}_{2} )}^{2}}{( {u}_{1}^{0} {u}_{2}^{0} + {u}_{1}^{T} {u}_{2} + 1 ) ( {u}_{1}^{0} + 1 ) ( {u}_{2}^{0} + 1 )} -$$

$$2 ] [ \frac{{( {u}_{1} \times {u}_{2} )}^{2}}{( {u}_{1}^{0} {u}_{2}^{0} + {u}_{1}^{T} {u}_{2} + 1 ) ( {u}_{1}^{0} + 1 ) ( {u}_{2}^{0} + 1 )} ] ++$$

$$\frac{{( {u}_{1}^{0} + {u}_{2}^{0} + {u}_{1}^{0} {u}_{2}^{0} + {u}_{1}^{T} {u}_{2} + 1 )}^{2} {( {u}_{1} \times {u}_{2} )}^{2}}{{[ ( {u}_{1}^{0} {u}_{2}^{0} + {u}_{1}^{T} {u}_{2} + 1 ) ( {u}_{1}^{0} + 1 ) ( {u}_{2}^{0} + 1 ) ]}^{2}} ==$$

$${\underbrace{\frac{{( {u}_{1} \times {u}_{2} )}^{2}}{{[ ( {u}_{1}^{0} {u}_{2}^{0} + {u}_{1}^{T} {u}_{2} + 1 ) ( {u}_{1}^{0} + 1 ) ( {u}_{2}^{0} + 1 ) ]}^{2}}}}_{in general \neq 0} \cdot \cdot$$

$$\{ [ {( {u}_{1} \times {u}_{2} )}^{2} - 2 ( {u}_{1}^{0} {u}_{2}^{0} + {u}_{1}^{T} {u}_{2} + 1 ) ( {u}_{1}^{0} + 1 ) ( {u}_{2}^{0} + 1 ) ] ++$$

$${( {u}_{1}^{0} + {u}_{2}^{0} + {u}_{1}^{0} {u}_{2}^{0} + {u}_{1}^{T} {u}_{2} + 1 )}^{2} \}$$

In the following we show that the second factor is zero:

$$[ {( {u}_{1} \times {u}_{2} )}^{2} - 2 ( {u}_{1}^{0} {u}_{2}^{0} + {u}_{1}^{T} {u}_{2} + 1 ) ( {u}_{1}^{0} + 1 ) ( {u}_{2}^{0} + 1 ) ] ++$$

$${( {u}_{1}^{0} + {u}_{2}^{0} + {u}_{1}^{0} {u}_{2}^{0} + {u}_{1}^{T} {u}_{2} + 1 )}^{2} == {( {u}_{1} \times {u}_{2} )}^{2} -$$

$$2 ( {u}_{1}^{0} {u}_{2}^{0} + {u}_{1}^{T} {u}_{2} + 1 ) ( {u}_{1}^{0} + 1 ) {( {u}_{2}^{0} + 1 ) ++ [ {u}_{1}^{T} {u}_{2} + ( {u}_{1}^{0} + 1 ) ( {u}_{2}^{0} + 1 ) ]}^{2} ==$$

$${u}_{1}^{2} {u}_{2}^{2} - {( {u}_{1}^{T} {u}_{2} )}^{2} - 2 ( {u}_{1}^{0} {u}_{2}^{0} + {u}_{1}^{T} {u}_{2} + 1 ) ( {u}_{1}^{0} + 1 ) ( {u}_{2}^{0} + 1 ) ++ {( {u}_{1}^{T} {u}_{2} )}^{2} +$$

$$2 {u}_{1}^{T} {u}_{2} ( {u}_{1}^{0} + 1 ) ( {u}_{2}^{0} + 1 ) + {[ ( {u}_{1}^{0} + 1 ) ( {u}_{2}^{0} + 1 ) ]}^{2} ==$$

$${u}_{1}^{2} {u}_{2}^{2} - 2 ( {u}_{1}^{0} {u}_{2}^{0} + {u}_{1}^{T} {u}_{2} + 1 ) ( {u}_{1}^{0} + 1 ) ( {u}_{2}^{0} + 1 ) ++$$

$$2 {u}_{1}^{T} {u}_{2} ( {u}_{1}^{0} + 1 ) ( {u}_{2}^{0} + 1 ) + [ {( {u}_{1}^{0} )}^{2} + 2 {u}_{1}^{0} + 1 ] [ {( {u}_{2}^{0} )}^{2} + 2 {u}_{2}^{0} + 1 ] ==$$

$${u}_{1}^{2} {u}_{2}^{2} - 2 ( {u}_{1}^{0} {u}_{2}^{0} + {u}_{1}^{T} {u}_{2} + 1 ) ( {u}_{1}^{0} + 1 ) ( {u}_{2}^{0} + 1 ) ++$$

$$2 {u}_{1}^{T} {u}_{2} ( {u}_{1}^{0} + 1 ) ( {u}_{2}^{0} + 1 ) + [ {u}_{1}^{2} + 2 {u}_{1}^{0} + 2 ] [ {u}_{2}^{2} + 2 {u}_{2}^{0} + 2 ] ==$$

$${u}_{1}^{2} {u}_{2}^{2} - 2 ( {u}_{1}^{0} {u}_{2}^{0} + {u}_{1}^{T} {u}_{2} + 1 ) ( {u}_{1}^{0} + 1 ) ( {u}_{2}^{0} + 1 ) ++$$

$$2 {u}_{1}^{T} {u}_{2} ( {u}_{1}^{0} + 1 ) ( {u}_{2}^{0} + 1 ) + [ {u}_{1}^{2} + 2 ( {u}_{1}^{0} + 1 ) ] [ {u}_{2}^{2} + 2 ( {u}_{2}^{0} + 1 ) ] ==$$

$${u}_{1}^{2} {u}_{2}^{2} - 2 {u}_{1}^{T} {u}_{2} ( {u}_{1}^{0} + 1 ) ( {u}_{2}^{0} + 1 ) - 2 ( {u}_{1}^{0} {u}_{2}^{0} + 1 ) ( {u}_{1}^{0} + 1 ) ( {u}_{2}^{0} + 1 ) ++$$

$$2 {u}_{1}^{T} {u}_{2} ( {u}_{1}^{0} + 1 ) ( {u}_{2}^{0} + 1 ) + {u}_{1}^{2} {u}_{2}^{2} +$$

$$2 ( {u}_{2}^{0} + 1 ) {u}_{1}^{2} + 2 ( {u}_{1}^{0} + 1 ) {u}_{2}^{2} + 4 ( {u}_{1}^{0} + 1 ) ( {u}_{2}^{0} + 1 ) ==$$

$${u}_{1}^{2} {u}_{2}^{2} - 2 {u}_{1}^{T} {u}_{2} ( {u}_{1}^{0} + 1 ) ( {u}_{2}^{0} + 1 ) -$$

$$2 ( {u}_{1}^{0} + 1 ) ( {u}_{2}^{0} + 1 ) + - 2 ( {u}_{1}^{0} {u}_{2}^{0} ) ( {u}_{1}^{0} + 1 ) ( {u}_{2}^{0} + 1 ) ++$$

$$2 {u}_{1}^{T} {u}_{2} ( {u}_{1}^{0} + 1 ) ( {u}_{2}^{0} + 1 ) + {u}_{1}^{2} {u}_{2}^{2} +$$

$$2 ( {u}_{2}^{0} + 1 ) {u}_{1}^{2} + 2 ( {u}_{1}^{0} + 1 ) {u}_{2}^{2} + 4 ( {u}_{1}^{0} + 1 ) ( {u}_{2}^{0} + 1 ) ==$$

$${u}_{1}^{2} {u}_{2}^{2} - 2 {u}_{1}^{T} {u}_{2} ( {u}_{1}^{0} + 1 ) ( {u}_{2}^{0} + 1 ) -$$

$$2 ( {u}_{1}^{0} + 1 ) ( {u}_{2}^{0} + 1 ) + - 2 ( {u}_{1}^{0} {u}_{2}^{0} ) [ {( {u}_{1}^{0} )}^{2} + {u}_{1}^{0} ] [ {( {u}_{2}^{0} )}^{2} + {u}_{2}^{0} ] ++$$

$$2 {u}_{1}^{T} {u}_{2} ( {u}_{1}^{0} + 1 ) ( {u}_{2}^{0} + 1 ) + {u}_{1}^{2} {u}_{2}^{2} +$$

$$2 ( {u}_{2}^{0} + 1 ) {u}_{1}^{2} + 2 ( {u}_{1}^{0} + 1 ) {u}_{2}^{2} + 4 ( {u}_{1}^{0} + 1 ) ( {u}_{2}^{0} + 1 ) ==$$

$${u}_{1}^{2} {u}_{2}^{2} - 2 {u}_{1}^{T} {u}_{2} ( {u}_{1}^{0} + 1 ) ( {u}_{2}^{0} + 1 ) -$$

$$2 ( {u}_{1}^{0} + 1 ) ( {u}_{2}^{0} + 1 ) + - 2 [ {u}_{1}^{2} + 1 + {u}_{1}^{0} ] [ {u}_{2}^{2} + 1 + {u}_{2}^{0} ] ++$$

$$2 {u}_{1}^{T} {u}_{2} ( {u}_{1}^{0} + 1 ) ( {u}_{2}^{0} + 1 ) + {u}_{1}^{2} {u}_{2}^{2} +$$

$$2 ( {u}_{2}^{0} + 1 ) {u}_{1}^{2} + 2 ( {u}_{1}^{0} + 1 ) {u}_{2}^{2} + 4 ( {u}_{1}^{0} + 1 ) ( {u}_{2}^{0} + 1 ) ==$$

$${u}_{1}^{2} {u}_{2}^{2} - 2 {u}_{1}^{T} {u}_{2} ( {u}_{1}^{0} + 1 ) ( {u}_{2}^{0} + 1 ) - 2 ( {u}_{1}^{0} + 1 ) ( {u}_{2}^{0} + 1 ) +$$

$$- 2 [ {u}_{1}^{2} {u}_{2}^{2} + {u}_{1}^{2} ( 1 + {u}_{2}^{0} ) + {u}_{2}^{2} ( 1 + {u}_{1}^{0} ) + ( 1 + {u}_{1}^{0} ) ( 1 + {u}_{2}^{0} ) ] ++$$

$$2 {u}_{1}^{T} {u}_{2} ( {u}_{1}^{0} + 1 ) ( {u}_{2}^{0} + 1 ) + {u}_{1}^{2} {u}_{2}^{2} +$$

$$2 ( {u}_{2}^{0} + 1 ) {u}_{1}^{2} + 2 ( {u}_{1}^{0} + 1 ) {u}_{2}^{2} + 4 ( {u}_{1}^{0} + 1 ) ( {u}_{2}^{0} + 1 ) = 0$$

Annex 9

In this annex the equivalence of equ.(34) and (35) is proven

$$\mathring{R} ( τ ) = equ . ( 34 ) = {( \begin{matrix}\frac{{u}^{0}}{\sqrt{{u}^{2}}} u & - \frac{u \times ( u \times a )}{\sqrt{{[ u \times ( u \times a ) ]}^{2}}} & \frac{u \times a}{\sqrt{{( u \times a )}^{2}}}\end{matrix} )}^{T} ( 1 - \frac{1}{{( {u}^{0} )}^{2}} {uu}^{T} ) \cdot \cdot ( \begin{matrix}\frac{a}{\sqrt{{a}^{2}}} & - \frac{( {u}^{0} a - {a}^{0} u ) \times ( u \times a )}{\sqrt{{{a}^{2} ( u \times a )}^{2}}} & \frac{u \times a}{\sqrt{{( u \times a )}^{2}}}\end{matrix} ) == [ ( \begin{matrix}\frac{{u}^{0}}{\sqrt{{u}^{2}}} {u}^{T} \\ - \frac{{[ u \times ( u \times a ) ]}^{T}}{\sqrt{{[ u \times ( u \times a ) ]}^{2}}} \\ \frac{{( u \times a )}^{T}}{\sqrt{{( u \times a )}^{2}}}\end{matrix} ) - \frac{1}{{( {u}^{0} )}^{2}} ( \begin{matrix}{u}^{0} \sqrt{{u}^{2}} \\ 0 \\ 0\end{matrix} ) {u}^{T} ] \cdot \cdot ( \begin{matrix}\frac{a}{\sqrt{{a}^{2}}} & - \frac{( {u}^{0} a - {a}^{0} u ) \times ( u \times a )}{\sqrt{{{a}^{2} ( u \times a )}^{2}}} & \frac{u \times a}{\sqrt{{( u \times a )}^{2}}}\end{matrix} ) == ( \begin{matrix}( \frac{{u}^{0}}{\sqrt{u}} - \frac{\sqrt{{u}^{2}}}{{u}^{0}} ) {u}^{T} \\ - \frac{{[ u \times ( u \times a ) ]}^{T}}{\sqrt{{[ u \times ( u \times a ) ]}^{2}}} \\ \frac{{( u \times a )}^{T}}{\sqrt{{( u \times a )}^{2}}}\end{matrix} ) \cdot ( \begin{matrix}\frac{a}{\sqrt{{a}^{2}}} & - \frac{( {u}^{0} a - {a}^{0} u ) \times ( u \times a )}{\sqrt{{{a}^{2} ( u \times a )}^{2}}} & \frac{u \times a}{\sqrt{{( u \times a )}^{2}}}\end{matrix} ) = …$$

In the following the nontrivial components (1,1), (1,2), (2,1), (2,2) of the matrix R̊(τ) are explicitly calculated:

$$( 1 , 1 ) = ( \frac{{u}^{0}}{\sqrt{{u}^{2}}} - \frac{\sqrt{{u}^{2}}}{{u}^{0}} ) {u}^{T} \frac{a}{\sqrt{{a}^{2}}} {=}^{{↓}^{u \cdot a = - {u}^{0} {a}^{0} + {u}^{T} a = 0}} ( \frac{{u}^{0}}{\sqrt{{u}^{2}}} - \frac{\sqrt{{u}^{2}}}{{u}^{0}} ) \frac{{u}^{0} {a}^{0}}{\sqrt{{a}^{2}}} == ( \frac{{u}^{2} + 1}{\sqrt{{u}^{2}}} - \sqrt{{u}^{2}} ) \frac{{a}^{0}}{\sqrt{{a}^{2}}} = \frac{{a}^{0}}{\sqrt{{u}^{2}} \sqrt{{a}^{2}}} \\$$

$$( 2 , 1 ) = - \frac{{[ u \times ( u \times a ) ]}^{T}}{\sqrt{{[ u \times ( u \times a ) ]}^{2}}} \frac{a}{\sqrt{{a}^{2}}} = \frac{{( u \times a )}^{2}}{\sqrt{{{u}^{2} ( u \times a )}^{2}}} \frac{1}{\sqrt{{a}^{2}}} = \frac{\sqrt{{( u \times a )}^{2}}}{\sqrt{{u}^{2}} \sqrt{{a}^{2}}}$$

$$( 1 , 2 ) = - ( \frac{{u}^{0}}{\sqrt{{u}^{2}}} - \frac{\sqrt{{u}^{2}}}{{u}^{0}} ) {u}^{T} \frac{( {u}^{0} a - {a}^{0} u ) \times ( u \times a )}{\sqrt{{{a}^{2} ( u \times a )}^{2}}} ==$$

$$- ( \frac{{u}^{0}}{\sqrt{{u}^{2}}} - \frac{\sqrt{{u}^{2}}}{{u}^{0}} ) {( u \times a )}^{T} \frac{u \times ( {u}^{0} a - {a}^{0} u )}{\sqrt{{{a}^{2} ( u \times a )}^{2}}} ==$$

$$- ( \frac{{u}^{0}}{\sqrt{{u}^{2}}} - \frac{\sqrt{{u}^{2}}}{{u}^{0}} ) \frac{{{u}^{0} ( u \times a )}^{2}}{\sqrt{{{a}^{2} ( u \times a )}^{2}}} = - \frac{\sqrt{{( u \times a )}^{2}}}{\sqrt{{u}^{2}} \sqrt{{a}^{2}}}$$

$$( 2 , 2 ) = \frac{{[ u \times ( u \times a ) ]}^{T}}{\sqrt{{[ u \times ( u \times a ) ]}^{2}}} \frac{( {u}^{0} a - {a}^{0} u ) \times ( u \times a )}{\sqrt{{{a}^{2} ( u \times a )}^{2}}} == \frac{{( {u}^{0} a - {a}^{0} u )}^{T}}{\sqrt{{{a}^{2} ( u \times a )}^{2}}} \frac{( u \times a ) \times [ u \times ( u \times a ) ]}{\sqrt{{[ u \times ( u \times a ) ]}^{2}}} == \frac{{( {u}^{0} a - {a}^{0} u )}^{T}}{\sqrt{{{a}^{2} ( u \times a )}^{2}}} \frac{{u ( u \times a )}^{2}}{\sqrt{{[ u \times ( u \times a ) ]}^{2}}} == \frac{( {u}^{0} {a}^{T} u - {a}^{0} {u}^{2} )}{\sqrt{{{a}^{2} ( u \times a )}^{2}}} \frac{{( u \times a )}^{2}}{\sqrt{{{u}^{2} ( u \times a )}^{2}}} = {=}^{u \cdot a = - {u}^{0} {a}^{0} + {u}^{T} a = 0} \frac{( {u}^{0} {u}^{0} {a}^{0} - {a}^{0} {u}^{2} )}{\sqrt{{a}^{2}}} \frac{1}{\sqrt{{u}^{2}}} = \frac{{a}^{0}}{\sqrt{{u}^{2}} \sqrt{{a}^{2}}}$$

Using these components the matrix R̊(τ) can now be written in matrix form by supplementing the trivial components (1,3), (2,3), (3,3), (3,1), (3,2):

$$… = ( \begin{matrix}\frac{{a}^{0}}{\sqrt{{u}^{2}} \sqrt{{a}^{2}}} & - \frac{\sqrt{{( u \times a )}^{2}}}{\sqrt{{u}^{2}} \sqrt{{a}^{2}}} & 0 \\ \frac{\sqrt{{( u \times a )}^{2}}}{\sqrt{{u}^{2}} \sqrt{{a}^{2}}} & \frac{{a}^{0}}{\sqrt{{u}^{2}} \sqrt{{a}^{2}}} & 0 \\ 0 & 0 & 1\end{matrix} ) = equ . ( 35 )$$

The following paragraph lists all cited documents:

[symbol]

### BIBLIOGRAPHY

[1] Donald E. Fahnline, A covariant four-dimensional expression for Lorentz trans-formations, American Journal of Physics, Vol. 50, Issue No. 9, pp. 818-821, September 1982, https://doi.org/10.1119/1.12748
[2] Abraham A. Ungar, THOMAS ROTATION AND THE PARAMETRIZA-TION OF THE LORENTZ TRANSFORMATION GROUP, Foundations of Physics Letters, Vol. 1, No. 1, pp. 57-89, 1988, https://link.springer.com/article/10.1007/BF00661317
[3] Howard Percy Robertson, Wigner W. Noonan, Relativity and Cosmology, 1968, W. B. Saunders company, Philadelphia, London, Toronto Library of Congress catalog card number 68-23690
[4] Eric Gourgoulhon, Special Relativity in General Frames-From Particles to As-trophysics, 2013, ISBN 978-3-642-37276-6 (eBook), Springer Berlin Heidelberg
[5] Oliver Davis Johns, Analytical Mechanics for Relativity and Quantum Mechan-ics, 2nd edition published 2011, first published in paperback 2016, Oxford University press, ISBN 978-0-19-876680-3 (PBK)
[6] Dennis S. Bernstein, Scalar, Vector, and Matrix Mathematics: Theory, Facts and Formulas, Revised and Expanded Edition, 2018, Princeton University Press, ISBN 9780691151205 (hardcover), ISBN 9780691176536 (paperback)
[7] John David Jackson, Classical Electrodynamics, Third Edition, John Wiley & Sons, 1998, ISBN 978-0-471-30932-1
[8] Michael Tsamparlis, Special Relativity-An Introduction with 200 Problems and Solutions, 2019, ISBN 978-3-030-27346-0, 2nd edition, Springer Nature Switzerland AG [9] Riad Chamseddine, Vectorial Form of the Successive Lorentz Trans-formations. Application: Thomas Rotation, Foundations of Physics, Volume 42, Issue 4, pp. 488-511, 2012, published online Feb. 12, 2011, https://link.springer.com/article/10.1007/s10701-011-9617-5
[10] W. L. Kennedy, Thomas rotation: a Lorentz matrix approach, EUROPEAN JOURNAL OF PHYSICS, Vol. 23, 2002, pp. 235-247, published 27 Mar. 2002, https://iopscience.iop.org/article/10.1088/0143-0807/23/3/301
[11] Leehwa Yeh, Wigner rotation and Euler angle parametrization, 22.06.2022, https://doi.org/10.48550/arXiv.2206.12406
[12] Bernhard Strohmayer, Expression for the four-dimensional Frenet-Serret frame of a given timelike worldline in Minkowski space, which expression encompasses the cases that the third 4D-curvature (second torsion, hypertorsion or bi-torsion) and possibly also the second 4D-curvature (first torsion) and possibly also the first 4D-curvature are vanishing, U.S. patent application Ser. No. 17/810,603 as originally filed, which can be downloaded under https://patentcenter.uspto.gov/applications/17810603/ifw/docs (pdf-link in the line with the document description ‘specification’). We do not refer to the application as published by the USPTO (publication number US 2023-0004623 A1), which is riddled with mistakes.

1. Method of calculating for two given restricted Lorentz transformation matrices ^{A}Lη and ^{B}Lη with identical first column vectors the rotation matrix Rη defined by
Rη=(^{A}Lη)^{-1B}Lη,
characterised in that the matrices are partitioned.

2. Method as defined in claim 1 in that equ.(25) is used.

3. Method as defined in claim 2 characterised in that the method is used to determine a Wigner rotation matrix (Thomas rotation matrix).

4. Method as defined in claim 2 characterised in that it is used to determine the rotation matrix linking two different local frames of the same timelike worldline in 4-dimensional Minkowski space.
